(19) United States
(12) Patent Application Publication
(10) Pub. No.: US 2012/0315081 A1
(43) Pub. Date: Dec. 13, 2012

(54) CONNECTOR DEVICES AND ASSEMBLIES FOR CONSTRUCTION AND SUPPORT OF BUILDINGS AND STRUCTURES, AND METHODS OF MAKING AND USING THEM

(76) Inventors: John Bouldin, Christiansburg, VA (US); Joseph Loferski, Blacksburg, VA (US); Rick Caudill, Blacksburg, VA (US); Kenneth Albert, Christiansburg, VA (US)

(21) Appl. No.: 13/393,956

(22) PCT Filed: Sep. 2, 2010
(86) PCT No.: PCT/US10/47749

§ 371 Date: Jul. 9, 2012

Related U.S. Application Data
(60) Provisional application No. 61/239,082, filed on Sep. 2, 2009.

(51) Int. Cl. E04B 1/58; F16B 9/00; E04B 1/38

(52) U.S. Cl. 403/205

(57) ABSTRACT

A method and an apparatus for attachment provide enhanced connecting integrity between various structural components. The method and apparatus have particular applicability in connection with connecting a post for a deck. The post is connected directly or indirectly by a connecting device which is secured against the surface of the post and to a surface of a joist loaded in shear. An anchor member may be fastened to the side of a joist and threadably receive a fastener which extends through a bore and, at the opposite end, is secured against the outside surface of a second joist. Connecting devices which employ L-shaped shank members are also employed. Transportable buildings and building kits comprising connecting assemblies of the invention are also included.

### CROSS-REFERENCE TO RELATED APPLICATION

This application relies on the disclosure of and claims priority to U.S. Provisional Patent Application No. 61/239,082 filed on Sep. 2, 2009, the disclosure of which is incorporated by reference herein in its entirety.

### BACKGROUND OF THE INVENTION

1. Field of the Invention

This disclosure relates generally to connector devices, assemblies, systems, and methods for improving the strength of connections and joints for structures and buildings. More particularly, this disclosure relates to connector devices and methods for connecting together various components of a structure, such as decks. Deck systems in particular can benefit from the connectors of the invention in that they are useful for connecting band joists and/or guard rail posts as part of the deck system and for connecting the deck to the house.

2. Description of the Related Art

Millions of wood decks and balconies have been constructed in the United States. Nearly 80% of new houses have decks. A recurring problem is that the conventional methods for attaching band joists to the deck structure, guard rail posts to the deck, and attaching the deck structure to the house structure is flawed and often does not comply with building code load requirements. When guard rail post connections, bandjoist-to-deck structure connections, and/or when deck-to-house connections fail, individuals can become seriously or fatally injured.

A problem with the conventional methods of attaching guardrail posts to decks is that although the bolts used to connect the post to the deck band-joist may be strong enough, the band joist attachment to the deck structure is a relatively weak connection. The band joist is typically attached to the joist by screws or nails installed into the end grain of the deck joist. Horizontal loads applied to the guard rail post cause the band joist to peel or rotate away from the deck joist because the nails or screws are loaded in withdrawal from the end grain, which is a very weak connection. In addition, when the guard rail is installed on a parallel deck joist, the connection between the post and deck must effectively transfer the load to the deck structure. This is also typically a relatively weak connection using conventional methods.

In addition, many older houses have decks whose construction does not meet minimum requirements specified by contemporary building codes. Improved methods and devices for providing strong guard rail post-to-deck connections, bandjoist-to-deck structure connections, deck-to-house connections, tie-down connections, uplift connections and shear-wall connections, as well as connections to retrofit existing decks and balconies can be addressed by various connecting devices and methods according to embodiments of this invention. The weakest connections are those that rely on fastening into the end grain of wood (or otherwise referred to as “in withdrawal” or “withdrawal from the end grain”). Avoiding or strengthening these connections by using the inventive connecting assemblies reduces the chance of failure from these weak connections and/or other known modes of failure.

In contrast, embodiments of the invention are stronger by employing from across-the-grain, against-the-grain, loaded in shear, or lateral loading to induce tension perpendicular to the grain type techniques.

### SUMMARY OF THE INVENTION

Briefly stated, a connection system, in one preferred form, is employed in the context of a deck installation. The connection system produces a connection between a bandjoist or a deck post and one or more deck joists or other components of the deck structure which involves fastening across the wood grain of the various structural members and does not rely on connections that depends on withdrawal strength from the end grain.

A connecting device for connecting a first structural element to a second structural element comprises a single piece device having shank and anchor portions. The shank has a first end (anchor) adapted for a securement against a surface of the first structural component and a second end (externally threaded shaft). The shank, in one embodiment, has a bend between the first end and the second end to provide an offset configuration. Preferably, the anchor portion is adapted to be secured against the first building component along a planar surface. The second end is adapted to be received and retained in a second building component abutting the first building component. The abutting surfaces can meet at any angle between 0-360°, although typically right angles will be used.

In a variation of this embodiment, the shank and anchor can be two separate structures. In such an embodiment, the shank can have a head at one end and a threaded shank at the opposing end. The anchor member has a planar surface for mounting to a substrate surface and is operably configured to receive the shank therein, either by receiving and retaining the threaded end or the head end.

Another embodiment of a connecting device for connecting a first structural component to a second structural component comprises an L-shaped member having two legs with the first leg having a remote first end and the second leg having a remote second end. The first end is threaded and a nut assembly is threadably engageable with the first end. The second end is threaded and further comprises a nut assembly threadably engageable with the second end.

In yet another connecting device embodiment comprising two L-shaped members, a second L-shaped member has two legs with the first leg end threaded and the second leg end threaded and wherein the second leg end of the first L-shaped member is also threaded. A connector or turnbuckle connects the second ends of the two L-shaped members. One leg of the L-shaped shaft and one leg of the connector have reverse threads, however, the first end of the L-shaped shaft has regular threads and the opposing end of the turnbuckle has regular threads. In one preferred application, a rim joist has a bore, and a deck joist to be connected to the rim joist has a bore. One leg is received in the rim joist bore and the first nut assembly is secured against the rim joist. A second leg is received in the deck joist bore and the second nut assembly is secured against the deck joist.

In one installation comprising a deck joist with a bore and a house joist with a bore wherein the joists are to be installed generally parallel to one another, a first leg of the first L-shaped member is received in the deck joist bore and secured by a first nut assembly. A first leg of the second L-shaped member is received in the house joist bore and secured by a second nut assembly. The L-shaped members are connected under tension by a tensioner to further secure the deck joist to the house joist.

Some specific embodiments of the invention include the following:

A connecting device comprising an elongated shaft having external threads on one cylindrical first end of the shaft and operably configured at a second end of the shaft to be capable of being secured by fasteners to a substrate in a manner in which the fasteners are loaded in shear relative to the substrate.

The device above-described, wherein the second non-threaded end of the shaft transitions and terminates into an anchor portion having a planar surface, is also included within the scope of the invention. In such devices, the anchor portion can comprise a plurality of openings for receiving fasteners.

Further included are such devices, wherein the shaft comprises a sloped transition into the anchor portion which provides the shaft and anchor offset relative to one another. Devices of the invention can further comprise: a nut operably configured to receive and retain the cylindrical end of the shaft; and fasteners for securing the anchor portion to a substrate.

Also included are such devices further comprising: an L-shaped foundation anchor having a threaded end; and a turnbuckle operably configured for receiving and retaining the threaded end of the shafts and the threaded end of the foundation anchor.

Devices include a connector comprising an elongated and cylindrical L shaped shaft having two ends and external threads on each end of the shaft.

Such devices can further comprise: a nut operably configured to receive and retain one threaded end of the shaft; an L-shaped foundation anchor having a threaded end; and a turnbuckle operably configured for receiving and retaining each of the threaded ends of the shaft and the foundation anchor.

Such devices can also further comprise nuts operably configured to receive and retain each cylindrical end of the shaft.

Embodiments include a connecting device comprising: a nut operably configured for receiving and retaining a threaded shaft; an elongated and cylindrical L-shaped shaft having external threads on one end of the shaft operably configured for being retained by the nut.

Further, a connecting assembly comprising: an elongated cylindrical shaft externally threaded at a first end and comprising a head at a second end; and an anchor member operably configured to be capable of contacting and supporting the head of the shaft and further operably configured to be capable of being secured by fasteners to a substrate in a manner in which the fasteners are loaded in shear relative to the substrate is also encompassed by the invention.

Connecting assemblies described herein can further comprise: an L-shaped foundation anchor having a threaded end; and a turnbuckle operably configured for receiving and retaining each of the threaded end of the shaft and the threaded end of the foundation anchor.

Also included is an assembly further comprising: an L-shaped foundation anchor having a threaded end different from the threaded end of the shaft; and an adapter operably configured for receiving and retaining each of the different threaded ends of the shaft and the foundation anchor.

Additionally considered is a connecting assembly comprising: a first and second elongated cylindrical shaft each externally threaded at a first end and comprising a head at a second end of the shaft; a first and second anchor member each operably configured to be capable of contacting and supporting a head of one of the first and second shafts and further operably configured to be capable of being secured by fasteners to a substrate in a manner in which the fasteners are loaded in shear relative to the substrate; and a turnbuckle operably configured for receiving and retaining the threaded end of each of the first and second shafts.

Equally applicable is a connecting assembly comprising: a first and second elongated and cylindrical L-shaped shaft each having two ends, wherein each end is externally threaded; nuts operably configured to receive and retain a first threaded end of each of the L-shaped shafts; and a turnbuckle operably configured for receiving and retaining a second threaded end of each of the first and second shafts.

A connecting assembly comprising: an elongated cylindrical shaft externally threaded at a first end and comprising a head at a second end; and an anchor member operably configured to be capable of receiving, contacting, and retaining multiple threads of the threaded first end of the shaft and further operably configured to be capable of being secured by fasteners to a substrate in a manner in which the fasteners are loaded in shear relative to the substrate is further encompassed by embodiments of the invention.

Other assemblies include those described herein, wherein the anchor member is operably configured with an interior ferrule for receiving, contacting, and retaining the threaded end of the shaft, and/or wherein the ferrule is connected to or integral with a face plate and the ferrule/face plate member is free floating yet captive within a housing of the anchor.

Provided assemblies can further comprise a sloped spacer member, which is a hollow cylinder sloped on one end and operably configured to contact and support the head of the shaft at an opposing end, and which provides a support surface for the head of the shaft disposed at a selected distance from a substrate.

Means for retaining fasteners and increasing the strength of a joint include anchor members comprising: a housing which is a single continuous sheet of material and which is operably configured to receive and encompass an end of a shaft-type connector; a ferrule connected to the housing or a ferrule connected to or integral with a face plate, wherein the ferrule/face plate member is free floating yet captive within the housing or the ferrule/face plate member is fixed within the housing, and wherein the ferrule is operably configured to receive, contact, and retain multiple threads of a threaded end of a shaft-type connector; and a support plate operably configured for fastening to a substrate with fasteners.

Further included in the scope of embodiments of the invention is a double anchor tensioner comprising two anchor members described herein.

Connector assemblies can comprise: two elongated cylindrical shaft members each externally threaded at one end and comprising a head at an opposing end; and a double-anchor tensioner for receiving and retaining the threaded shaft ends.

The invention includes a building kit comprising: one or more headers, beams, rim joists, band joists, deck joists, cross blocks, guard rail posts, house joists, ledger boards, exterior sheathing, studs, sill plates, floor boards, sub-floors, plywood panels, oriented strand boards, top plates, rafters, or trusses; and one or more connectors, connector devices, connector assemblies, anchors, or tensioners herein described. Other components can be additionally included. This list is not exhaustive.

Such building kits are included, wherein any one or more of the headers, beams, rim joists, band joists, deck joists, cross blocks, guard rail posts, house joists, ledger boards, exterior sheathing, studs, sill plates, floor boards, sub-floors, plywood panels, oriented strand boards, top plates, rafters, or trusses, etc., comprises pre-drilled bores for accommodating any of the one or more connectors, connecting devices, connecting assemblies, anchors, or tensioners herein described.

A temporary or transportable building comprising: one or more component headers, beams, rim joists, band joists, deck joists, cross blocks, guard rail posts, house joists, ledger boards, exterior sheathing, studs, sill plates, floor boards, sub-floors, plywood panels, oriented strand boards, top plates, rafters, or trusses; and one or more component connectors, connector devices, connector assemblies, anchors, or tensioners, etc., herein described are also embodiments of the invention.

Such buildings can be transportable or capable of assembly, disassembly, and re-assembly by re-using the components.

Methods include a method of securing a deck post to a deck system comprising: providing one or more connecting assembly described herein; installing the anchor member of the connecting assembly to a deck joist using fasteners in a manner that provides the fasteners loaded in shear relative to the joist; securing the deck post to the deck system by inserting the elongated cylindrical threaded shaft into and through the deck post, into and through an intermediate rim joist, and into the anchor member for retaining the threaded end of the shaft therein.

Another method of stabilizing an outside joist or rim joist can comprise: providing one or more connecting assembly herein described; installing the anchor member of the connecting assembly to a cross block disposed between and abutting two joists in a building system, using fasteners in a manner that provides the fasteners loaded in shear relative to the cross block; securing an outermost joist within the building system by inserting the elongated cylindrical threaded shaft into and through the outermost joist and into the anchor member for retaining the threaded end of the shaft therein; and securing the innermost joist within the building system by inserting the elongated cylindrical threaded shaft into and through the innermost joist and into the anchor member for retaining the threaded end of the shaft therein.

Methods can further comprise securing a guard rail post abutting the outermost joist by inserting the elongated cylindrical threaded shaft into and through the guard rail post prior to inserting the shaft through the outermost joist and into the anchor for retaining therein.

Further included is a method of stabilizing a band joist comprising: providing one or more connecting device described herein; installing the threaded end of the shaft of the connecting device in one face and through the other face of a pre-drilled band joist; installing a nut or nut assembly on the threaded end of the shaft to retain the shaft within the band joist; positioning and installing the anchor portion of the connecting device to a side of a deck joist using fasteners in a manner that provides the fasteners loaded in shear relative to the joist; tightening the nut to secure the joint.

Such methods can also comprise securing a guard rail post abutting the band joist by installing and securing the threaded end of the shaft in and through a pre-drilled band joist, then in and through a pre-drilled guard rail post; installing a nut or nut assembly on the threaded end of the shaft to retain the shaft within the guard rail post and band joist; positioning and installing the anchor portion of the connecting device to a side of a deck joist using fasteners in a manner that provides the fasteners loaded in shear relative to the joist; tightening the nut to further secure the joint.

Further included is a method of stabilizing a rim joist comprising: providing one or more connecting device described herein; installing a first threaded end of the L-shaped shaft of the connecting device into a pre-drilled bore of a deck rim joist; installing a second threaded end of the shaft of the connecting device into a pre-drilled bore of a deck joist; installing a nut on each shaft end; and securing the rim joist to the deck joist by tightening the each nut until secure.

Embodiments further include a method of securing outer and inner deck joists comprising: providing one or more connecting device herein described; installing a first threaded portion of the L-shaped shaft of the connecting assembly in and through a pre-drilled bore of an inner deck joist and in an through a pre-drilled bore of an outer deck joist; wherein the first portion of the shaft is abutting a cross block disposed between and abutting the inner and outer deck joists; and wherein a second portion of the shaft is disposed abutting the inner deck joist; and securing the outer joist to the inner joist by installing and tightening a nut on the first threaded end of the shaft.

Such methods can further comprise securing a guard rail post, which is abutting and is secured to the cross block, by inserting the first portion of the shaft of the connecting assembly in and through a pre-drilled bore of the guard rail post after installing it through the inner deck joist but before installing the shaft in and through the outer deck joist.

Yet further is a method of securing a deck joist with a house joist comprising: providing one or more connecting assembly of described herein; installing a first end of a first L-shaped shaft in and through a pre-drilled bore disposed in a side of a house joist and securing the first end of the first shaft with a nut on an opposing side of the house joist; installing a first end of a second L-shaped shaft in and through a pre-drilled bore disposed in a side of deck joist and securing the first end of the second shaft with a nut on an opposing side of the deck joist; installing a turnbuckle to receive and retain a second end of each of the first and second L-shaped shafts and tightening the turnbuckle to secure the deck joist to the house joist in a manner in which the connecting assembly is loaded in shear in the deck joist and the house joist.

Methods of securing a deck joist to a house rim joist or securing a house joist to a deck ledger board may comprise: providing one or more connecting assemblies described herein; installing a first threaded end of an elongated shaft of the connecting assembly in and through a pre-drilled bore disposed in a house rim joist or deck ledger board; securing the second anchor end of the shaft of the connecting assembly to a deck joist or house joist, respectively, with fasteners in a manner that provides the fasteners loaded in shear with respect to the deck or house joist; securing the first end of the shaft with a nut and tightening the nut until secure.

Also included is a method of securing a deck joist to a house rim joist or securing a house joist to a deck ledger board comprising: providing one or more connecting assemblies described herein; installing the anchor member of the connecting assembly to a deck joist or house joist using fasteners in a manner that provides the fasteners loaded in shear relative to the deck joist or house joist; securing the deck joist or house joist to, respectively, a house rim joist or a deck ledger board by inserting the elongated cylindrical threaded shaft of the connecting assembly into and through the house rim joist or deck ledger board, respectively, and into the anchor member for retaining the threaded end of the shaft therein.

A method of securing a deck joist with a house joist comprising: providing one or more connecting assembly described herein; installing a first and second anchor member loaded in shear to, respectively, a deck joist and a house joist; providing a turnbuckle between the first and second anchors; inserting the first elongated cylindrical threaded shaft of the connecting assembly into the first anchor until the head of the shaft is retained therein and inserting the threaded end of the first shaft into one end of the turnbuckle; inserting the second elongated cylindrical threaded shaft of the connecting assembly into the second anchor until the head of the shaft is retained therein, inserting the second shaft into and through the house rim joist and deck ledger board, and inserting the second shaft into an opposing end of the turnbuckle; twisting the turnbuckle to increase tension between the anchors.

Another method of securing a deck joist or a house joist to a support may comprise: providing one or more connecting assembly described herein; installing a first and second anchor member loaded in shear to, respectively, a deck joist and a house joist; inserting the first and second elongated cylindrical threaded shaft of the connecting assembly into and through the house rim joist and deck ledger board for retaining the threaded end of the shaft therein.

Even further methods include methods of securing a stud to a foundation comprising: providing one or more connecting assembly described herein; installing the connecting assembly loaded in shear onto a stud; inserting the threaded end of the shaft of the assembly into a turnbuckle or adapter operably configured to retain the shaft therein; connecting the turnbuckle or adapter with a foundation anchor fixed in a foundation; turning the turnbuckle or shaft to increase tension between the anchor in the stud and the foundation anchor thereby securing the stud to the foundation.

A method of stabilizing a guard rail post can also comprise: providing one or more connecting device described herein; installing an anchor portion of the connecting device loaded in shear to a deck joist using fasteners; inserting the threaded end of the shaft of the connecting device in and through a guard rail post, an abutting band joist, and into the anchor; and securing the post, band joist, and deck joist by turning the shaft to pull the threads of the shaft into the anchor under tension.

Yet still other methods may include securing a rafter, truss, or stud to a top plate comprising: providing one or more connecting assembly described herein; installing a first and second anchor member loaded in shear to, respectively, a rafter, truss, or stud; inserting the first and second elongated cylindrical threaded shaft of the connecting assembly into and through the top plate and into the anchor or into and through the anchor and into the top plate, wherein the threaded end of each shaft is retained in the anchor or top plate.

Methods of the invention include stabilizing a band joist to a deck joist comprising: providing one or more connecting assembly described herein; installing the anchor member of the connecting assembly to a side of a deck joist loaded in shear using fasteners; installing the shaft of the connecting assembly in and through a band joist and into the anchor member for retaining the threaded end of the shaft therein; and tightening the shaft into the anchor member by turning the shaft until secure.

The embodiments of the invention can be adapted for practical situations by omitting any of the elements described for a particular embodiment or by combining elements from one embodiment with another.

### BRIEF DESCRIPTION OF THE DRAWINGS

FIG. 1 is a schematic side sectional elevation view of a deck system showing use of the connecting devices according to an embodiment of the invention, which illustrates a representative way by which a deck guard rail post may be secured into a deck system using a connecting device of the invention.

FIG. 2A is a schematic top sectional view of a portion of a deck system, which illustrates use of connecting devices of the invention to secure two non-adjacent deck joists, for example, an inner deck joist and an outermost deck joist.

FIG. 2B is a schematic top sectional view of a portion of a deck system, which illustrates securing of two non-adjacent deck joists, for example, an inner deck joist and an outermost deck joist, and a deck guard rail post into a deck system using connecting devices of the invention.

FIG. 3 is a schematic top sectional view of a portion of a deck system, which illustrates a connecting device of the invention installed for securing a band joist to a deck joist, or any two or more adjacent or abutting supports.

FIG. 4 is a schematic perspective view of the system of FIG. 3.

FIG. 5 is a schematic top sectional view of a portion of a deck system, which illustrates another connecting device according to the invention joining a deck rim joist with a deck joist.

FIGS. 6A and 6B are schematic top sectional views of a portion of a deck system, which illustrate use of connecting devices according to embodiments of the invention for joining a deck rim joist with two non-adjacent deck joists with (FIG. 6A) or without (FIG. 6B) a cross block between the non-abutting deck joists.

FIGS. 7A and 7B are schematic top sectional views of a portion of a deck system, which illustrate a representative way for securing an outer deck joist to an inner non-abutting deck joist using an embodiment of the connecting devices according to the invention, wherein the connecting device does (FIG. 7A) or does not (FIG. 7B) further support and join a deck guard rail post into the deck system.

FIGS. 8A-E are schematic top sectional views of a portion of a deck system, which illustrates representative ways for securing the deck system to a house by using a connector system according to embodiments of the invention which allow for an across-the-grain securing of the connector system into the house and deck joists.

FIGS. 9A-C are schematic side sectional elevation views of a portion of a building structure, which illustrates embodiments of connecting devices according to the invention installed as part of a tie-down connection between a stud and an existing anchor bolt of a house.

FIG. 10 is a schematic side sectional elevation view of a portion of a deck system, illustrating forces that may be imposed on a deck system during use and how a connecting device according to embodiments of the invention may be used for securing a deck guard rail post to a deck joist to oppose such forces and resist pullout, such as by positioning the connector at about center of the side of the deck joist.

FIG. 11 is a schematic side sectional elevation view of a portion of a deck system, illustrating forces that may be imposed on a deck system during use and how a connecting device according to embodiments of the invention may be used for securing a deck guard rail post to a deck joist to oppose such forces and resist pullout, such as by positioning the connecting device at approximately the top of the deck joist.

FIG. 12 is a schematic side sectional elevation view of a portion of a deck system, illustrating use of a connecting device system according to embodiments of the that involves positioning two connecting devices in an against-the-grain manner against and into the side of a deck joist, where one connecter is disposed at the top region and the other at the bottom region of the side of the deck joist.

FIG. 13 is a schematic side sectional elevation view of a portion of a deck system, illustrating an embodiment of the connecting devices of the invention installed for securing a guard rail post or other vertical support member to a deck joist.

FIG. 14 is a schematic top sectional view of an inventive connecting device as installed for securing a deck guard rail post to a deck joist.

FIGS. 15A and 15B are schematic side sectional elevation views of a portion of a building structure, which illustrate use of a pair of connecting devices according to embodiments of the invention for securing a rafter or truss to top plates and to a stud to resist an uplift loading.

FIG. 16 is a schematic side sectional elevation view of a portion of a building structure, which illustrates a connector assembly according to the invention for securing a stud to an existing anchor bolt.

FIG. 17 is a schematic side sectional elevation view of a portion of a deck system, which illustrates a connector assembly of the invention installed for securing a deck band or rim joist to an abutting deck joist, wherein the connector assembly provides a floating plate in the anchor for allowing multiple angles of shank insertion.

FIGS. 18A-D are respectively top plan, bottom plan, front elevation, and side elevation views of an anchor plate that may be used as part of the connector devices, assemblies, and systems according to the invention.

FIGS. 19A-C are respectively side elevation, top plan, and front elevation views of a representative connector assembly according to the invention.

FIGS. 20A-C are respectively side elevation, top plan, and front elevation views of a representative connector assembly according to the invention.

FIGS. 21A and 21B are respectively a schematic top sectional view of a portion of a deck system and a close up view of a portion of the top sectional view, which illustrate use of connectors according to the invention for joining a deck rim joist to abutting deck joists in an against-the-grain fashion at a relative angle other than perpendicular, for example, at approximately 45°.

FIGS. 21C and 21D are respectively a schematic top sectional view of a portion of a deck system and a close up view of a portion of the top sectional view, which illustrate use of connectors according to the invention for joining a deck rim joist to abutting deck joists in an against-the-grain fashion at a relative angle other than perpendicular, for example, at approximately 45°, and for joining and securing of a deck guard rail post into the deck system.

FIGS. 21E and 21F are respectively a schematic top sectional view of a portion of a deck system using a connector assembly of the invention that comprises an installation adaptor, which can be sloped, and a close up view of the assembly.

FIG. 22 is an illustration of an anchor according to the invention.

FIG. 23 is a representative connecting device according to the invention comprising an anchor capable of performing as a tensioner (e.g., turnbuckle) capable of receiving and retaining two opposing elongated cylindrical shaft-type fasteners.

FIG. 24 is an illustration of the anchor shown in FIG. 23.

### DETAILED DESCRIPTION OF VARIOUS EMBODIMENTS OF THE INVENTION

With reference to the drawings, a number of installations are illustrated in the context of connections being provided by various connecting devices and techniques. Most of the illustrated installations are in the context of decks constructed in conjunction with a house or residence, although there are numerous possible installations which involve connecting and/or securing and/or stabilizing other structures. The structural components are typically wood products, but can include any substrate, for example, plastic, metals, composites, carbon fiber materials, etc. A significant consideration in each of the illustrated installations is to strengthen and enhance connections between structures which conventionally involve and rely on, indirectly or directly, the engagement of fasteners into the end grain of a wood component. In many installations described below additions of multiple installed connecting devices may be used rather than the single or dual connections described. In some cases, the connections will be made in unusual configurations that may not always result in connections exclusively to joists. In addition, the connecting devices implement connections which supplement and reinforcement conventional and/or pre-existing connections.

“Nut assembly” and “nut” as used in this description can refer to a nut, a nut and integral washer, or a nut and one or more washers, including a spacer washer. Any of these terms can be used interchangeably, or in the plural or singular form, and are understood to perform the same overall function.

The terms connector, assembly, device, system, connector assembly, connector device, connector system, connecting assembly, connecting device, connecting system, etc. may be used interchangeably, or in the plural or singular form, in this disclosure to refer to embodiments of the connectors, assemblies, devices, and systems according to the invention. If a singular form of the terms is used, it is not meant to exclude other components of the devices. For example, a connector according to the invention may refer to the shaft portion of a connector, and/or the anchor portion, and/or a tensioning portion, and/or a nut or nut assembly, and so forth.

Further, it is not critical that a distinction be made between a joist, deck joist, rim joist, and band joist and these terms may be used interchangeably within this disclosure. In embodiments described herein, if a distinction is needed it will be explained in more detail, for example, in typical deck systems a rim joist may be placed in a certain direction, while the deck joist may be placed in another direction relative to the rim joist, such as perpendicular to one another but other configurations are possible.

The term “fastener(s)” as used in this disclosure can refer any means for securing one object to another and is not intended to be limiting. If the singular form of the term is used, modifications can be made by including multiple fasteners instead, or vice versa. If a particular type of fastener is described with respect to a particular embodiment, it should be understood that substitutions, as appropriate, may be made for replacing the specified fastener with any other fastener or type of fastener. As a non-limiting list, fasteners and such fastening means according to the invention can include one or more, or combinations of any of the following, or any similar device: nails, screws, bolts, adhesives, and/or welds. For example, where screw-type fasteners may be preferred for installations of the connecting assemblies into wood, welding the anchor member or portion of the connecting assembly to a metal substrate would be equally applicable. Likewise, if the substrate support is carbon fiber, for example, an adhesive might be preferred. Similarly, even if using screw-type fasteners to secure an anchor plate to a wood substrate, the connection could be reinforced by including an adhesive between the anchor plate and wood surface as well.

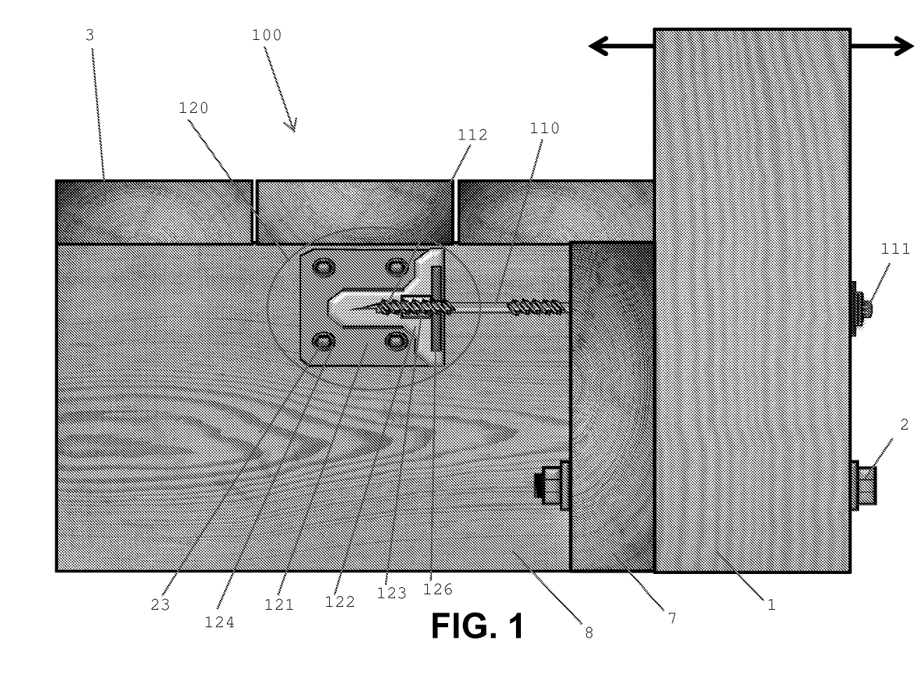

With reference to FIG. 1, a connecting device 100 is installed for securing a deck post 1 which abuts a rim joist 7, and a deck joist 8 with various deck boards 3. Although these primary components are described in this embodiment, it should be understood that other components could additionally be included in the deck system embodiments according to the invention, such as including structural sheathing panels (e.g., plywood and/or oriented strand board, OSB) with the floor decking materials. Deck guard rail post 1 is secured to the deck structure with the additional assistance of a conventional bolt assembly 2. As shown in FIG. 1, bolt assembly 2 provides a weak or no connection (as shown) between the deck post 1 and the deck joist 8. With traditional bolt assemblies 2, the bolt is fastened only to rim joist 7 (as shown) or is secured to deck joist 8 at the end of deck joist 8 where the bolt is inserted along and in line (“in withdrawal”) with the grain of the wood of deck joist 8.

Although in this embodiment and the embodiments to follow it has been described that connectors of the invention are preferred for strengthening the joint between two or more wood-based supports, the connectors are equally suitable for use with other materials, including for example metals, composites, plastics, carbon fiber materials or any type of substrate, especially substrates typical in construction.

In the embodiment shown in FIG. 1, connecting device 100 comprises an elongated fastener 110 and an anchor plate 120. The elongated fastener 110 is configured to be capable of being driven and/or inserted through deck post 1 and rim joist 7. One end of the elongated fastener 110 comprises a head 111 and the opposing end 112 is configured for insertion into a substrate, such as wood, metal, plastic, composites, etc., (e.g., pointed) and threaded for connection with anchor plate 120.

More particularly, in this embodiment anchor plate 120 comprises a planar surface 121 for mating against a side surface of the deck joist 8. Anchor plate 120 further comprises a protruding boss 122 (or housing), which houses an internal threaded bore 123 (ferrule 123 or ferrule/face plate combination, 123/126). The threaded bore 123 can be integral to the anchor plate, can be a ferrule, or a separate or free-floating connection. Threaded bore 123 of anchor plate 120 and the threaded end 112 of elongated fastener 110 are operably configured for mating with one another. Anchor plate 120 comprises means for securing the anchor plate 120 to deck joist 8, such as holes 124 and corresponding fasteners 23, which are capable of penetrating deck joist 8 in a manner that is against the grain of deck joist 8 (e.g., side entry or loaded in shear). The fastening integrity may be ensured by the positioning of the fasteners 23 on or through the anchor plate 120 at a desired position relative to the rim joist 7 and the deck boards 3. It will be appreciated that anchor plate 120 and fasteners 23 provide for a more secure connection of deck post 1 with the deck structure by allowing for securing of deck post 1 directly to deck joist 8 as compared with using the conventional bolt 2 alone.

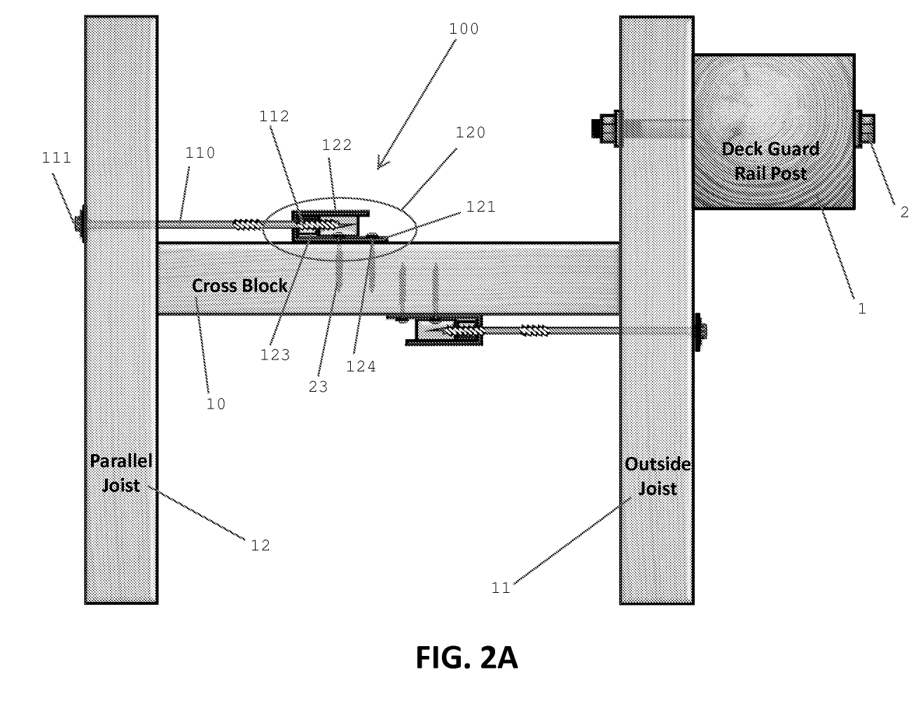

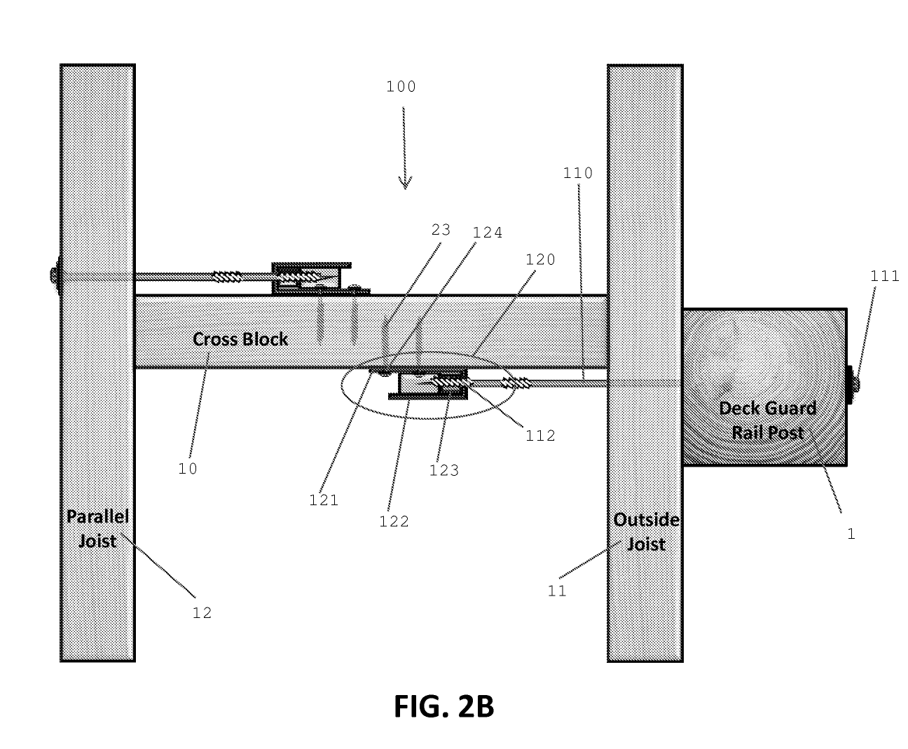

FIGS. 2A and 2B provide an example of how connector assemblies 100 can be used according to embodiments of the invention to secure two deck joists and optionally a deck guard rail post. As shown in FIG. 2A, a deck post 1 may be secured to the deck structure by conventional bolt assembly 2 (as shown) and/or by using any of the inventive connectors. Two connector assemblies 100 are used to connect, support, and strengthen the connection between two deck joists 12, 11 using one or more cross blocks 10. The shank of elongated fastener 110 is driven and/or inserted through the side of the deck joist 11, 12 in a manner that provides head 111 flush with deck joist 11, 12. Threaded end 112 of elongated fastener 110 is configured for being threadably received into threaded portion 123 (ferrule) of boss 122 (housing) of anchor plate 120.

The anchor plate 120 is fastened to a side of cross block 10 using fasteners 23, which are driven into cross block 10 against/across the grain (loaded in shear). The type of fasteners or fastening means used to secure the anchor plate 120 to a substrate is not critical and can include, for example, nails, screws, and/or through-bolts. Ideally, for each cross block 10 a connecting device 100 is installed on opposing sides of the cross block 10. For the illustrated installation, it should be appreciated that a bolt assembly 2 or other fastener which extends through the post 1 and the outermost deck joist 11 connects across the grain. Support for deck post 1 installed in this manner does not rely on a connection through the end grain of deck joist 11, but essentially connects directly to deck joist 11 across the grain and additional support for joists 11, 12 is provided using connectors 100 and cross block 10 in an across-the-grain manner, thus providing a superior connection and overall deck system.

In addition to these just-described elements, FIG. 2B illustrates how securing of a deck guard rail post 1 can be included in the systems of the invention. As shown in FIG. 2B, a connector assembly 100 can be inserted through the deck guard rail post 1 and then through an abutting outside deck joist 11 to then connect with the anchor plate 120, which is anchored in and to cross block 10 in an against-the-grain manner for securing the deck post 1 to the cross block 10.

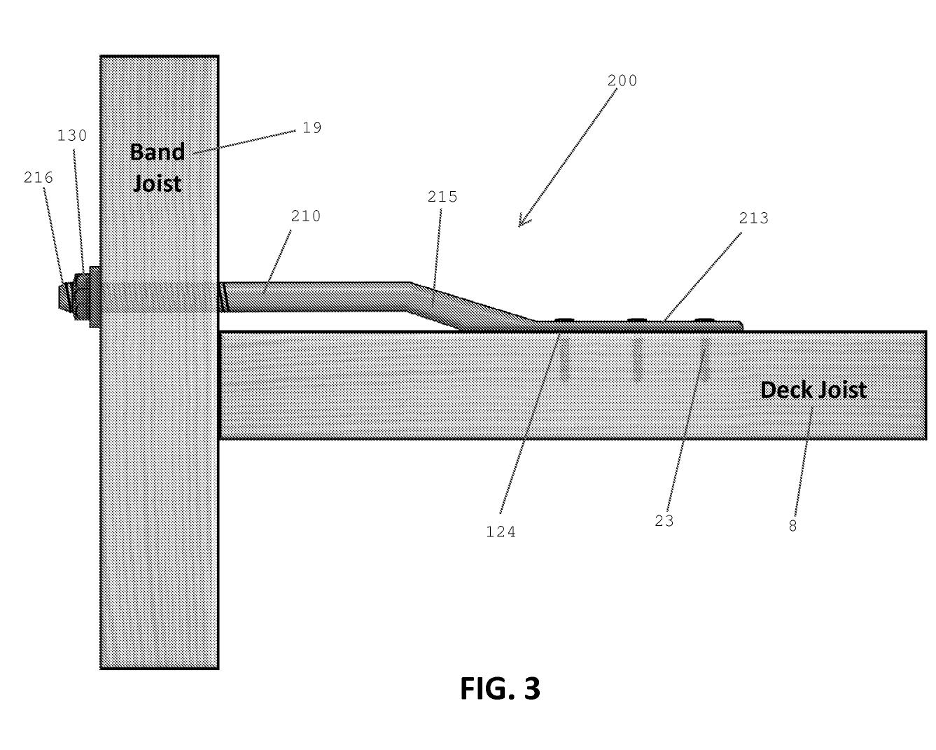

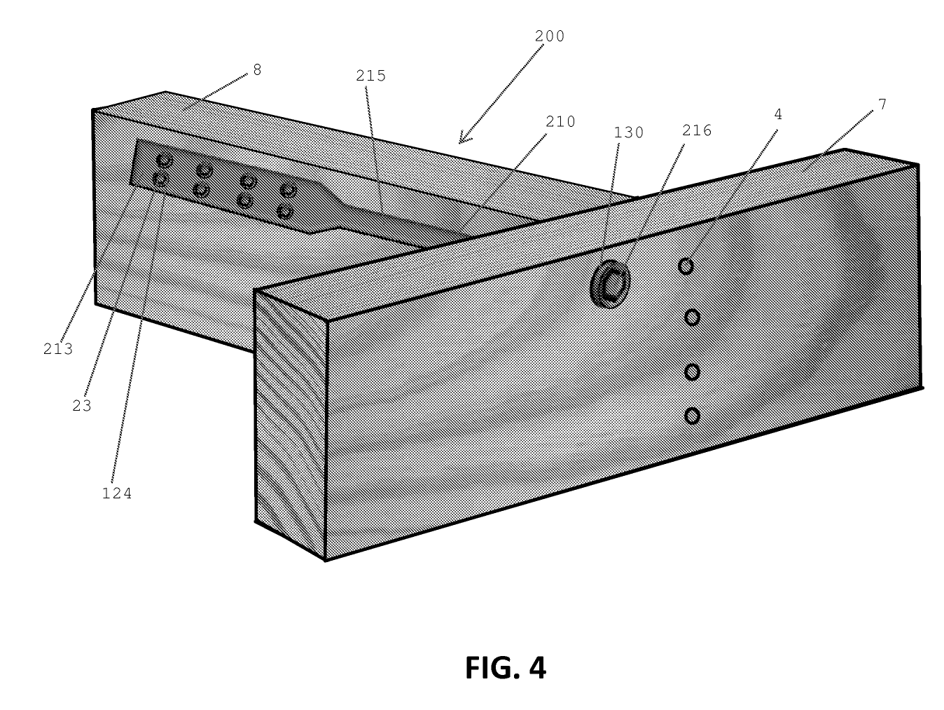

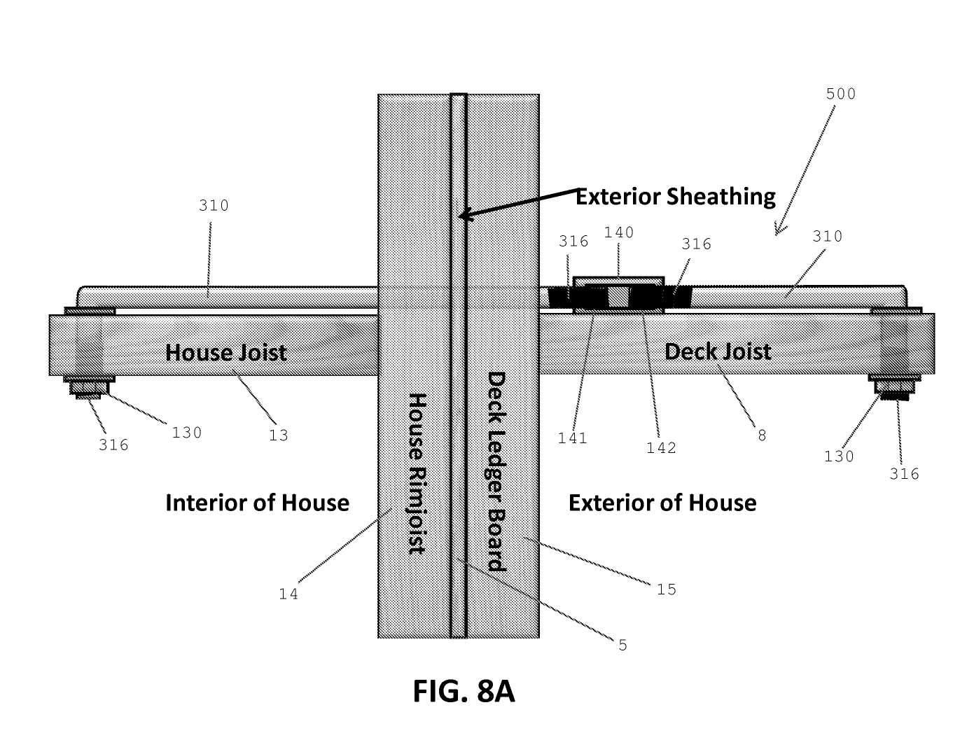

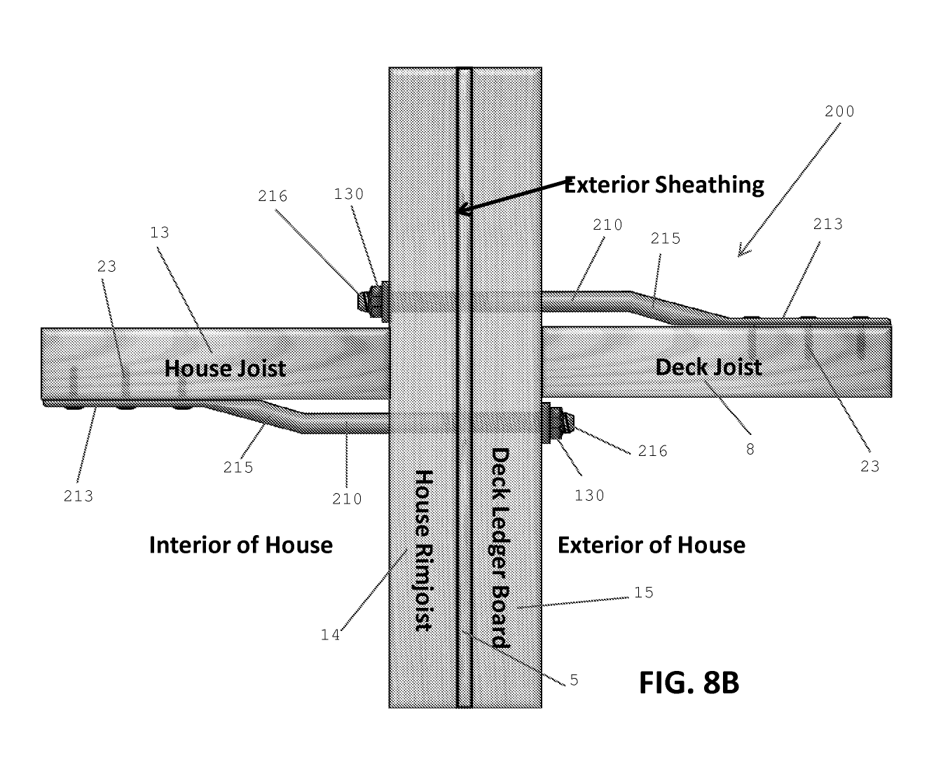

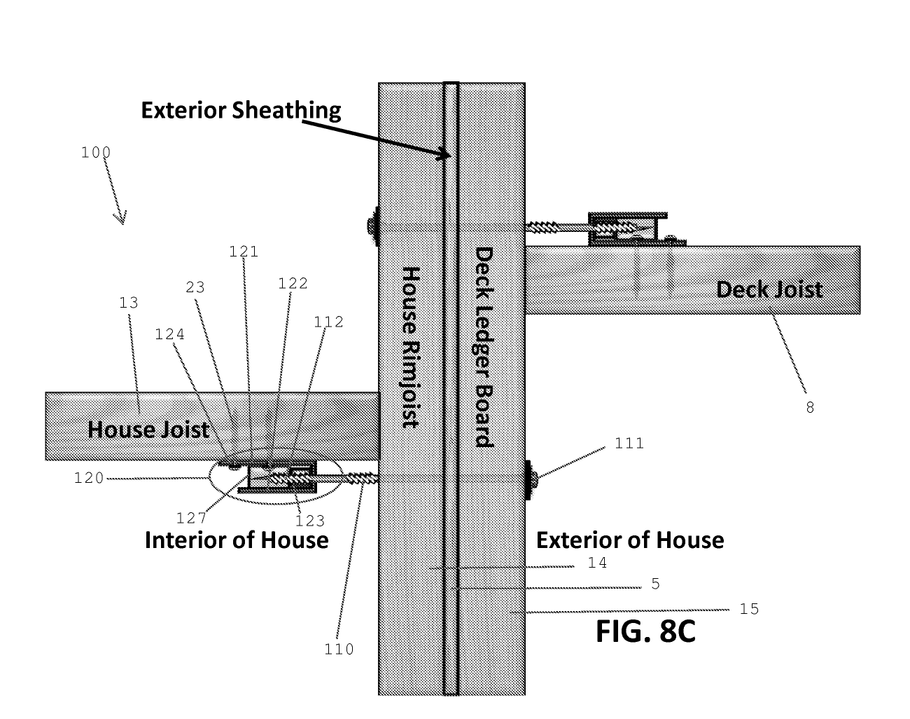

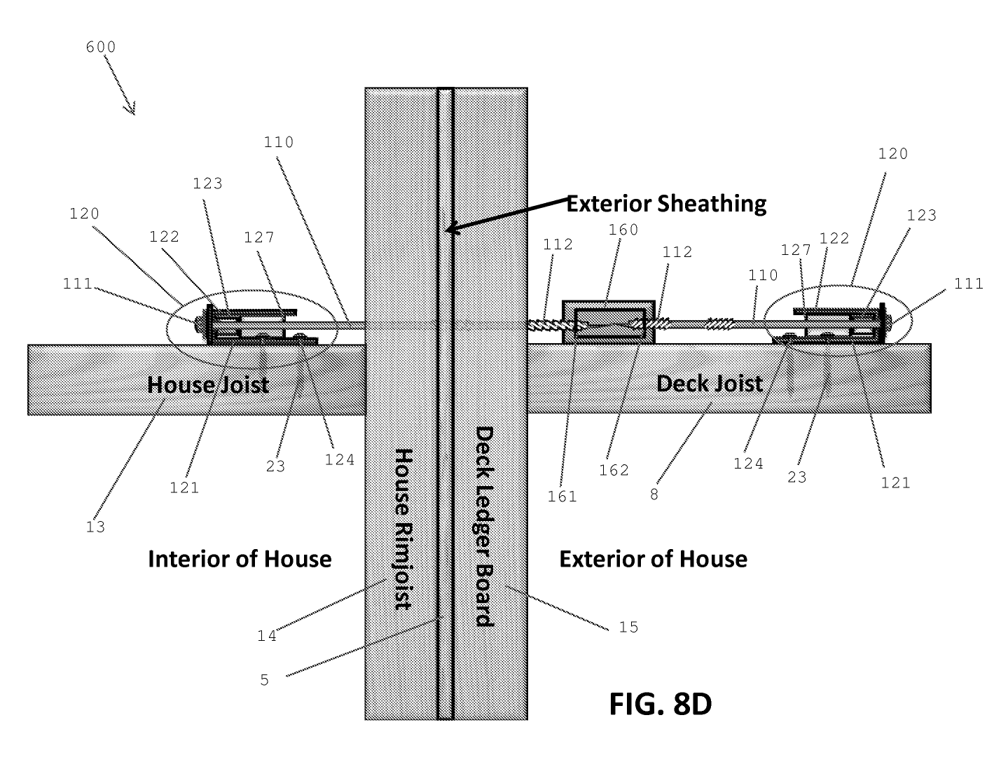

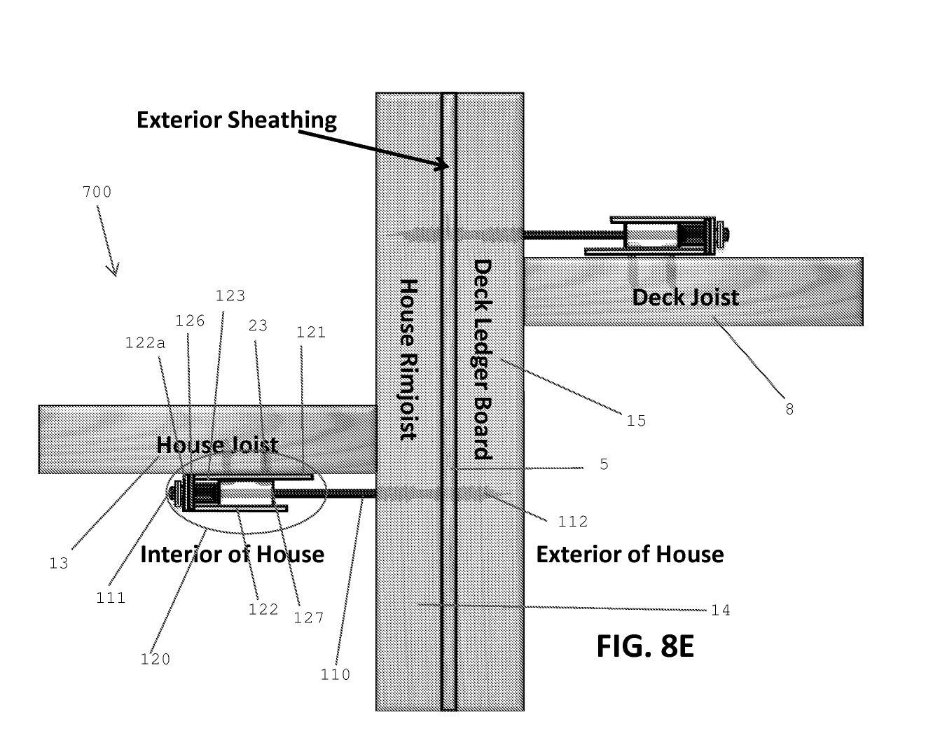

FIGS. 3 and 4 provide another embodiment of a connecting assembly according to the invention, connector device 200. This is one of the more universal connectors according to the invention in that it is easily applied and/or adapted for use with a number of other structure systems and/or substrate materials (see also, FIG. 8B).

More particularly, FIG. 3 provides a side view and FIG. 4 provides a front perspective view of connector device 200 joining together and supporting the connection between deck joist 8 and a band joist 19 or rim joist 7. As shown, connecting device 200, comprises an elongated fastener 210 having a threaded end 216 that extends into an offset (bent) shank portion 215 (e.g., a shallow intermediate bend) and terminates in an integral anchor plate 213 or comprises a means for connecting the elongated fastener shaft 210 with an anchor plate. Anchor plate 213 comprises openings 124 through which fasteners 23 can be driven across the grain (loaded in shear) into deck joist 8. The band joist 19 (or rim joist 7) can be configured to have a bore through which the threaded end 216 of the shank projects.

For stabilizing the deck structure, the threaded portion 216 of the connector device 200 is inserted in and through deck band joist 19 (or deck rim joist 7) and a nut is secured thereto. The other end of the connector, anchor 213, is secured to deck joist 8 with fasteners 23 inserted through holes 124. The nut 130 is then tightened (preferably against a washer) to provide a secure connection between band joist 19 (or rim joist 7). Additionally shown in FIG. 4 are additional securing means 4 (nails) for an in withdrawal type attachment between the band joist 19 (or rim joist 7) and deck joist 8, which is not in itself a strong connection.

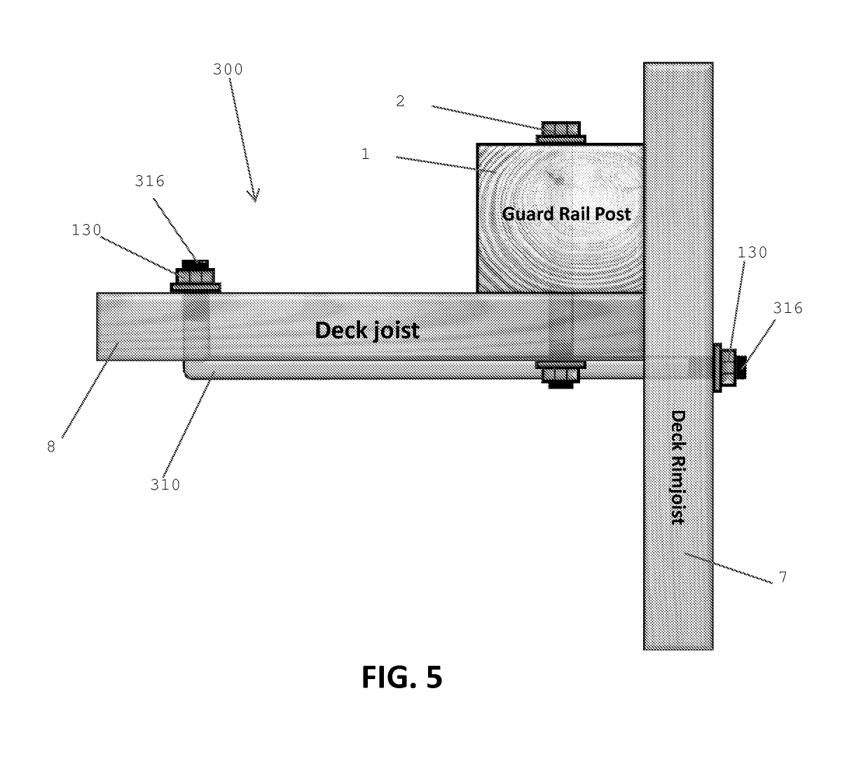

FIG. 5 shows an embodiment of a connecting device 300 having a generally L-shaped shank 310 configuration, wherein the connector 300 is shown employed for connecting a deck rim joist 7 and deck joist 8. The extreme ends 316 of the L-shaped shank 310 are threaded for mating with a nut 130. Bores are pre-formed in the deck joist 8 and the rim joist 7. The threaded ends 316 of L-shaped shank 310 are secured by torquing a nut assembly 130 (which in this embodiment includes a washer) against one side of deck joist 8 and against the outside of deck rim joist 7. The deck guard rail post 1 can be secured by a conventional bolt assembly 2 (as shown) or another connector according to the invention (not shown), which connects through or against the deck guard rail post 1 and the deck joist 8.

As shown, in this embodiment, each of the connections connect across the grains of the structural elements and is thus stronger than (better resistance to pullout) using the conventional bolt alone.

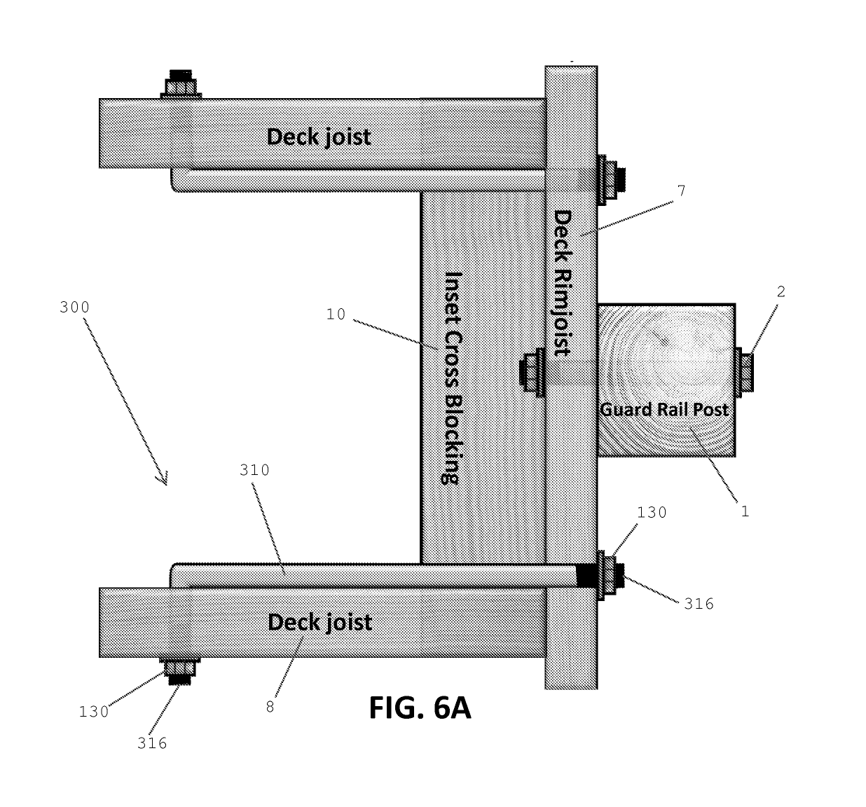

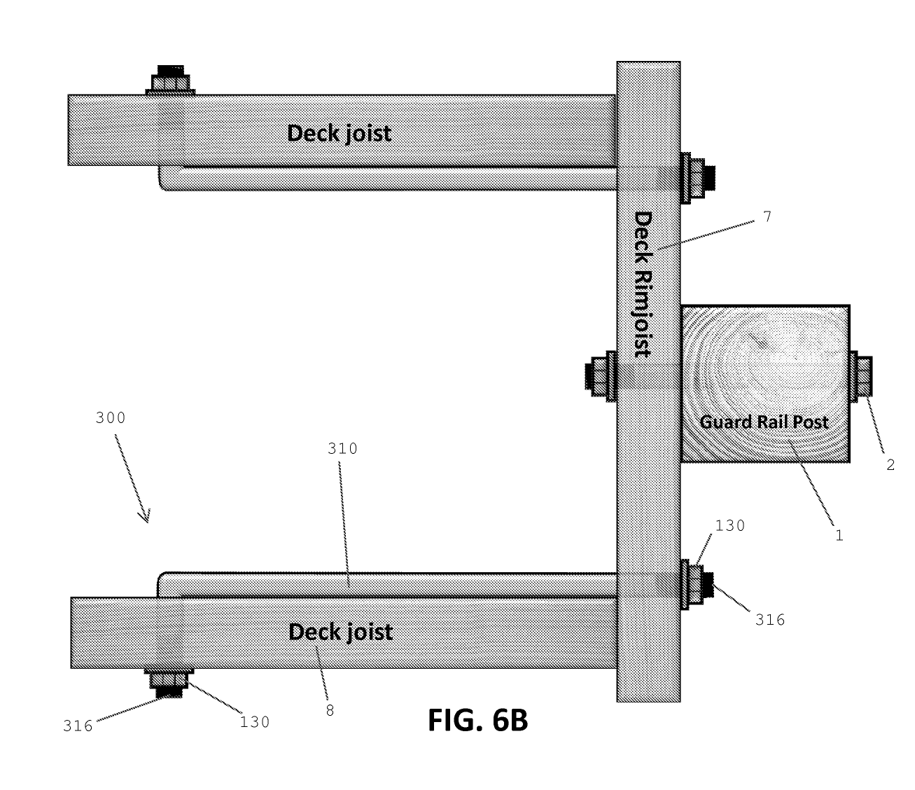

FIGS. 6A and 6B are schematic drawings illustrating the use of two connecting devices 300 for connecting/strengthening deck joists 8 (typically, which can be disposed generally parallel relative to each other) and a deck rim joist 7. In this installation, the deck guard rail post 1 is secured outside of the deck rim joist 7 by means of a conventional bolt/nut/washer combination 2, which again connects and secures across and against the grain of the structural elements. The connecting devices 300 connect at the opposed sides of the generally parallel deck joists 8 and through pre-formed or pre-drilled bores in the deck rim joist 7. The connectors 300 comprise an L-shaped shank 310 each with two threaded ends 316, which are secured by a nut/washer combination 130. It should be appreciated that the deck rim joist 7 is joined by the connecting devices 300 across the grain of the deck joists 8 and does not rely on fastening through the ends of the deck joists 8, which results in a much stronger connection. Additionally, for increased support of the deck joist/deck rim joist connection, a cross block member 10 may also be included but is not required (shown in FIG. 6A but omitted from FIG. 6B).

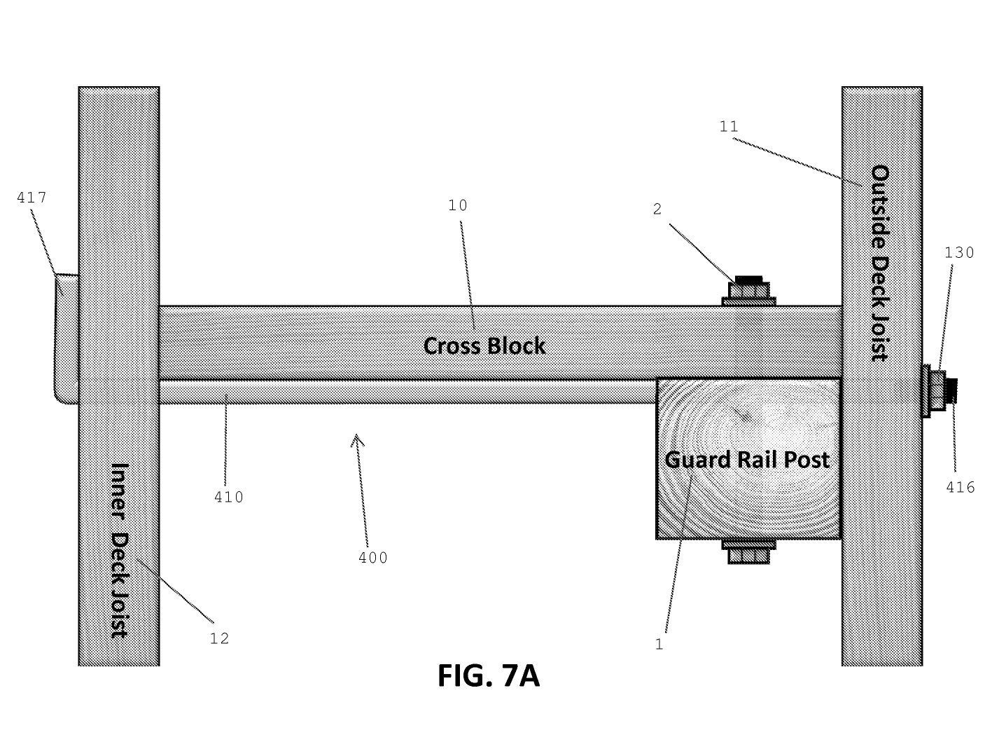

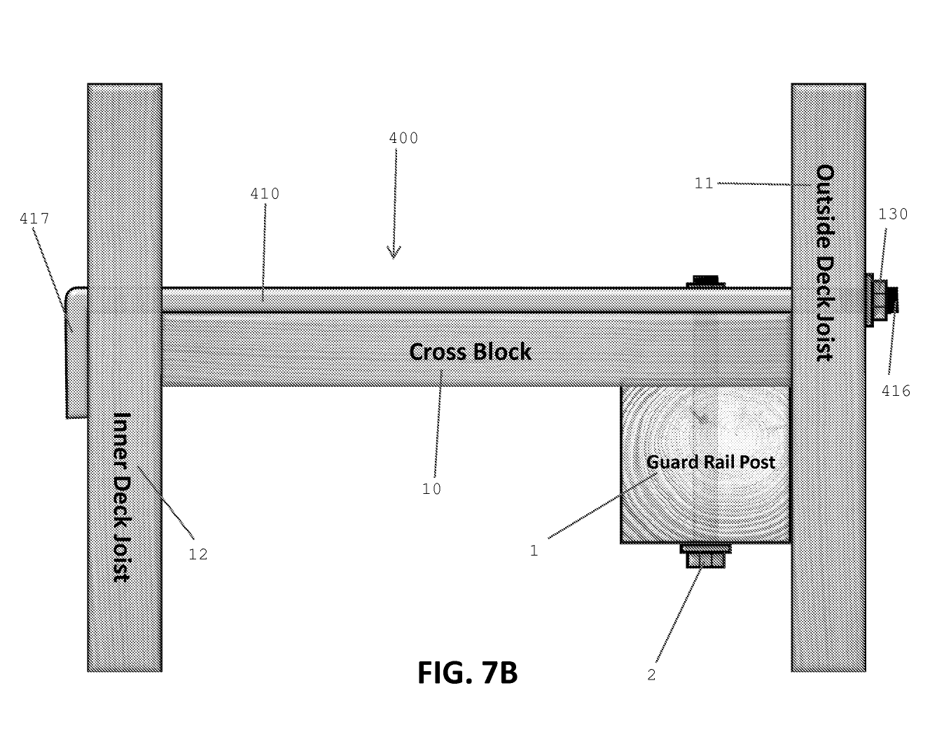

FIGS. 7A and 7B are schematic representations of another embodiment according to the invention. As shown in FIG. 7A, a connecting device 400 with an L-shaped shank 410 is adapted for connecting two non-abutting deck joists, here an outermost deck joist 11 and an inner deck joist 12. To secure the guard rail post 1 into the deck system, a conventional bolt assembly 2 is fastened through the deck guard rail post 1 and secured across the grain of cross block 10 (FIG. 7A) or the connector 400 can be used (FIG. 7B). The connecting device 400 is L-shaped and one end of shaft 410 extends through a pre-formed bore in the outermost deck joist 11 and includes a threaded end 416, which is secured by a nut assembly 130 against the outside face of outermost deck joist 11 (FIG. 7A) or against the outermost face of the deck guard rail post 1 abutting the outermost deck joist 11 (FIG. 7B). Another bore through the innermost disposed deck joist 12 allows the second leg of the L-shaped shaft 410 of connector 400 to retainably engage against the opposing side of the innermost deck joist 12. In this manner, the outermost deck joist 11 (FIGS. 7A and 7B) can be secured to the innermost deck joist 12 in an against-the-grain manner without compromising the strength of the connection. Likewise, as in FIG. 7B, the deck guard rail post 1 can be similarly secured. In contrast, typical deck systems would secure the outermost deck joist 11 within the deck system by fastening it directly to cross block 11 through end an end of the cross block, at which point the fastener would enter into the support substrate in line with the grain, which results in a weaker connection.

FIGS. 8A-D are schematic top sectional views of a portion of a deck system, which illustrates representative ways for securing the deck system to a house by using a connector system according to embodiments of the invention which allow for securing of the connector system into the house and deck joists in a manner in which the connector assemblies are loaded in shear into the joist substrates.

FIG. 8A provides a schematic diagram showing use of the connector embodiments according to the invention for securing a deck system to a house by securing the deck joists to the house joists in a loaded in shear fashion. As shown in FIG. 8A, connecting assembly 500 includes a pair of steel L-shaped shanks 310 joined together with a tensioner 140. Pre-formed bores are formed in a house joist 13 and a deck joist 8 in an across-the-grain manner (loaded in shear). Both ends 316 of the shank 310 are threaded. A first such end is threaded for engagement with a nut assembly 130 (which in this embodiment includes a nut, a washer, and a spacer washer). This threaded end 316 is disposed in the bore of house joist 13 and extends through to protrude from the opposing side, where the connector is secured by the nut assembly 130. The other end 316 of shank 310 is also threaded and is fed in and through the house rim joist 14, any exterior structural sheathing (which may typically be disposed between the house rim joist 14 and the deck ledger board 15), and the deck ledger board 15. This other end 316 of shank 310 is operably configured to mate with one threaded bore 141 of a tensioner 140.

A second L-shaped shank 310 is included in the connector system. This second L-shaped shank 310 is similarly disposed in and through the deck joist 8 in an against-the-grain manner, while the other end 316 is operably configured for mating with an opposing end of bore 142 (with thread reverse of 141) in the tensioner 140. The tensioner device 140 is threaded toward the center of the bore from each end in a manner that provides for the threads of one end of the bore to be the reverse of the threads of the other end. As the tensioner 140 is turned, tension increases pulling the threaded 316 portion of shafts 310 into the tensioner 140 to provide stabilization of the deck and house joist connection.

FIG. 8B provides an example where the connectors 200 can be used to join together and support a deck system to a house. As shown, connecting device 200 comprises an elongated member 210 having a threaded end 216 that extends into an offset shank portion 215 (e.g., a shallow intermediate bend) and terminates in an integral anchor plate 213 or comprises a means for connecting the elongated member 210 with an anchor plate. Anchor plate 213 comprises openings through which fasteners 23 (here, screws) can be driven across the grain into house joist 13. One connector 200 is fastened in an against-the-grain manner to house joist 13 and the other connector 200 is fastened in a similar manner to deck joist 8.

In preferred embodiments, the house rim joist 14, exterior sheathing 5, and deck ledger board 850 can be configured to have a bore through which the threaded end 216 of the shank projects. For assembly, the threaded end 216 of connectors 200 is each placed in a separate bore the extends through the house rim joist 14, sheathing 5, and deck ledger board 15 to protrude from the opposing side of member 15. The protruding portion of each elongated member 210 is then mated with a separate nut assembly 130. Nut assemblies 130 are then tightened to provide two secure connections: 1) between house rim joist 140 and deck joist 8 and 2) between deck ledger board 15 and house joist 13 in an across-the-grain type manner (if using wood) or otherwise referred to as loaded in shear with respect to the substrate.

FIG. 8C provides another example where the connector assemblies 100 can be used to join together and support a deck system to a house. As shown, two connector assemblies 100 are used to connect, support, and strengthen the connection between a deck joist 8 and a house joist 13, which are shown in this embodiment offset from one another. The shank of elongated fastener 110 is driven and/or inserted through the house rim joist 14 (with a pre-drilled bore or no bore), the exterior sheathing 5, and the deck ledger board 15 along one side of the house joist 13. The shank of a second elongated fastener 110 is likewise inserted along an opposing side of the deck joist 8. This provides head 111 in combination with a washer of one of the connectors 100 secured against the house rim joist 14 and the other head 111 secured against the deck ledger board 15.

Threaded end 112 of elongated fastener 110 is configured for being threadably received into threaded portion of ferrule 123 of anchor plate 120. One of the anchor plates 120 is fastened to a side of house joist 13, while the other anchor plate 120 is fastened to an opposing side of deck joist 8 using fasteners 823 (e.g., screws), which are driven into the substrate and loaded in shear with respect to the substrate (i.e., against/across the grain, if using wood). By turning the heads 111 of the connector assembly shafts 110, the shafts 110 are pulled into anchor member 120 and tension is increased securing the joint. The shaft 110 is protected by housing 122 of anchor 120 by being completely encompassed therein with end panel 127.

FIG. 8D illustrates yet another example of using connectors 600 according to the invention for joining together and supporting a deck system and a house. As shown, a connector assembly 600 comprising an anchor member 120 is secured across-the-grain to a house joist 13 using fasteners 23 (here, screws). An elongated shaft 110 with a head 111 is inserted through a bore in a side of the anchor 120 that is adjacent to the side secured to the house joist 13. The head 111 which is larger than the bore or opening in anchor plate 120 is retained therein. At an end opposing the head 111 of elongated member 110 is another end, a threaded end 112, which is inserted into and through the house rim joist 14, any exterior sheathing 5, and deck ledger board 15 to protrude from the opposing side of deck ledger board 15. Threaded end 112 of this connector 600 is inserted into and communicates with a tensioner 140.

A second connector 600 is secured in an across-the-grain fashion to deck joist 8 in a manner similar to that of securing the first connector to house joist 13. The elongated member 110 of the second fastener has a head 111, which is inserted into the anchor plate 120 of the second connector 600 and retained therein. The opposing threaded end 112 of the elongated member 110 is then inserted into an opposing end of the tensioner 140. Tensioner 140, which comprises a threaded bore at one end 141 and reverse threads 142 at the opposing bore, is then activated by turning it to draw the elongated members 110 into the tensioner 140 which tightens the joist connection.

FIG. 8E shows how connector assemblies 700 according to the invention can be used to stabilize a deck joist 8 with a deck ledger board 15 or to stabilize a house joist 13 with a house rim joist 14. As shown, two connector assemblies 700 are used to connect, support, and strengthen the connections. A first anchor member 120 is fastened to a side of house joist 13, while a second anchor plate 120 is fastened to a side of deck joist 8 using fasteners 23, (e.g., screws), which are driven into the substrate loaded in shear (i.e., against/across the grain, if using wood).

The shank of a first elongated fastener 110 is loaded into the first anchor 120 and driven and/or inserted into the house rim joist 14, the exterior sheathing 5, and/or the deck ledger board 15. The shank of a second elongated fastener 110 is likewise inserted into the second anchor 120 and driven and/or inserted into the deck ledger board 15, any exterior sheathing 5, and/or the house rim joist 14. Head 111 of each shaft is tightened against each anchor 120 until the joint is secure.

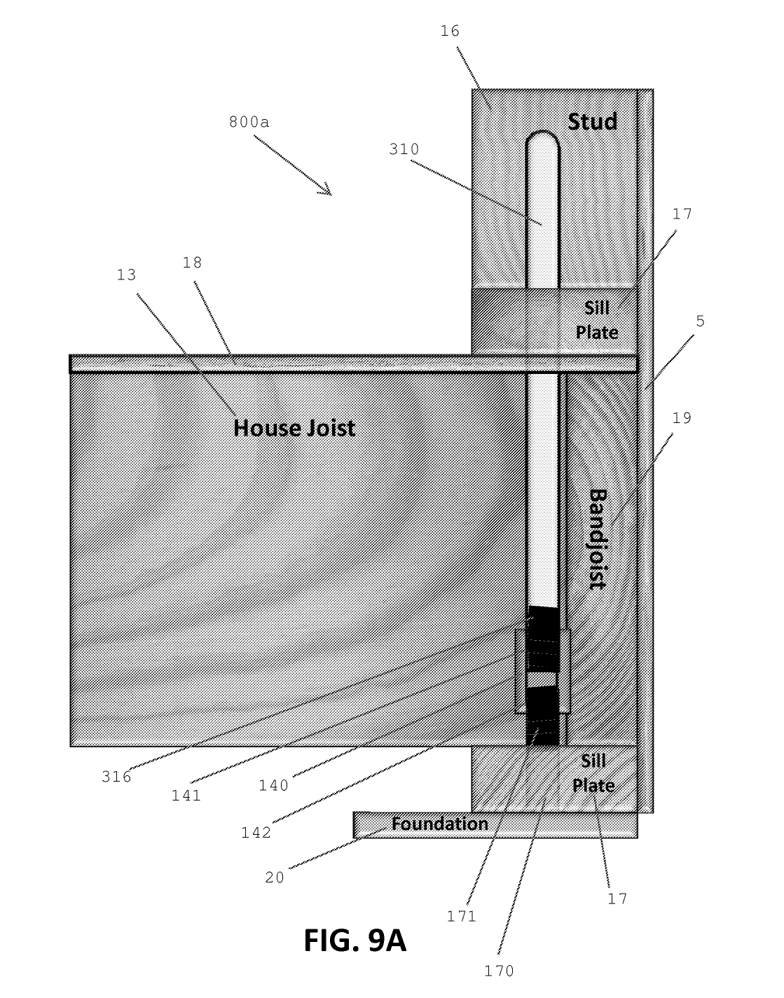

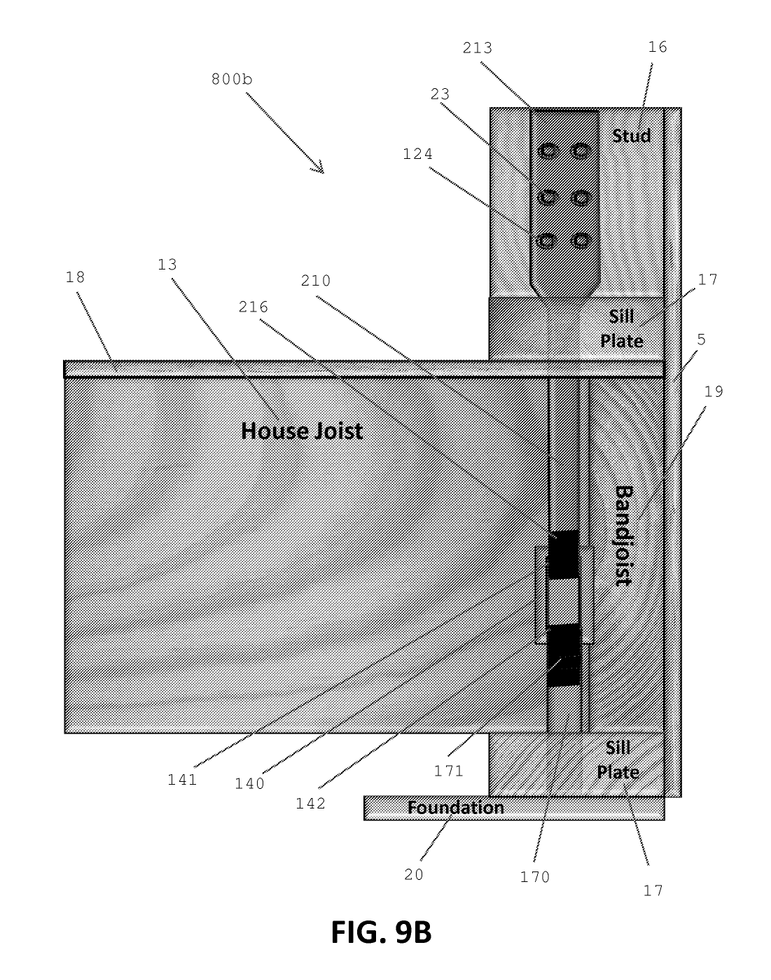

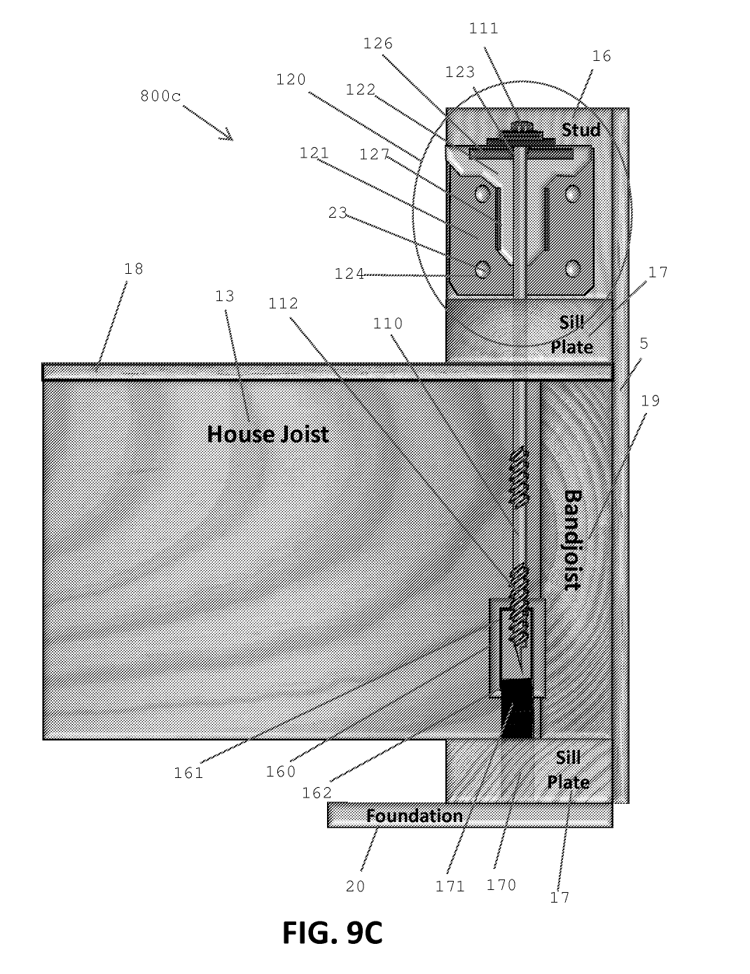

FIG. 9A shows a connecting device 800a employed as a stud tie-down against an uplift load. The connecting assembly 800a employs a single L-shaped member 310, a tensioner 140, and an L-shaped anchor bolt 170. A tensioner as used in this disclosure typically refers to a structure having two receptacles 141, 142 for receiving threaded shaft members. One of the receptacles is threaded in one direction 141, while the other receptacles is threaded in reverse 142. When such a tensioner (also known as a turnbuckle) is turned, the shaft 310 in each receptacle is pulled into the tensioner structure 140. With the other end of each shaft secured to a support, the supports are similarly under tension. The tensioner 140 threadably connects to the existing anchor bolt 140 of the house. The connecting device 800a has an L-shaped configuration as previously described for FIGS. 8A-E and comprises a threaded end 316 for communication with the tensioner 140 and an elongated shaft 310. The member 310 includes a threaded end (not illustrated) and extends through a pre-formed bore in the stud 16 and is secured by a nut and washer (not shown). In this manner, the building components, stud 16, upper sill plate 17, flooring 18, bandjoist 19, and lower sill plate 17, are secured to foundation 20.

FIG. 9B provides an alternative connecting assembly to perform the same function as described in FIG. 9A. A connecting device 800a, a tensioner 140, and an L-shaped concrete anchor 170 are combined to secure the joint between a stud 16, upper sill plate 17, flooring 18, bandjoist 19, lower sill plate 17, and the foundation 20.

The connecting device 800b comprises a planar end 213, which is an anchor portion of the device. The anchor 213 is secured to the stud 16 by fasteners 23 inserted in through holes 124 in the planar end 213. In this manner, the fasteners 23 are loaded in shear with respect to the substrate stud 16. The anchor portion 213 transitions into a shaft portion 210. The transition preferably involves two bends in the shaft 210 at a first positive angle at a certain degree then a second bend at a negative angle with the same measurement as the first bend. This provides the anchor 213 offset from the shaft portion 210 and in a non-intersecting plane. Along the shaft 210 and at an opposing end 216 of the shaft, the shaft is threaded. This threaded end 216 is received and retained by a tensioner 140, which is in operable communication with a foundation anchor 170 fixed in the foundation. As the tensioner 140 is turned, the connection tightens by pulling the shaft 210 and the foundation anchor 170 (specifically, the threaded ends 216, 171 of each) into the tensioner 140, thus, pulling the stud 16 and the foundation 20 together in a manner that will resist pull out of the stud and other components between the stud and foundation from the building structure when subjected to uploading forces.

FIG. 9C provides yet another modification of the connecting joints described in FIGS. 9A and 9B, connecting assembly 800c. More particularly, a concrete anchor 170 is installed into a foundation 20 of a building structure with the threaded shaft 171 protruding therefrom. An adapter 160 is in operable communication with the threaded portion 171 of concrete anchor 170.

On a stud 16 disposed above the concrete anchor 170, an anchor member 120 of a connecting assembly is installed loaded in shear into the stud 16. A cylindrical shaft 110, which is threaded at one end 112 and comprises a head 111 at an opposing end, is received in an through the anchor 120 in a manner to provide the opposing threaded end 112 in communication with a threaded bore 161 of adapter 160. As the shaft 110 is turned, it is pulled into the threaded bore 161 and tensioned against anchor member 120 at the head 111 of the shaft. This tightening action pulls the stud toward the foundation creating a secure connection. In this configuration, the threads 161, 162 of the adapter 160 are different.

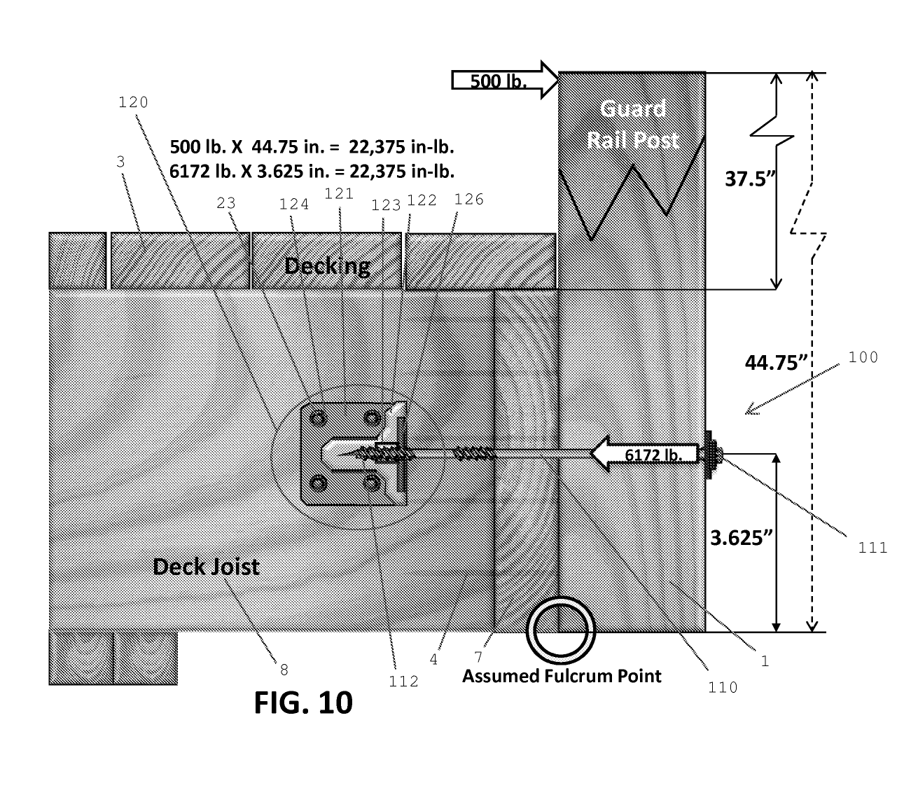

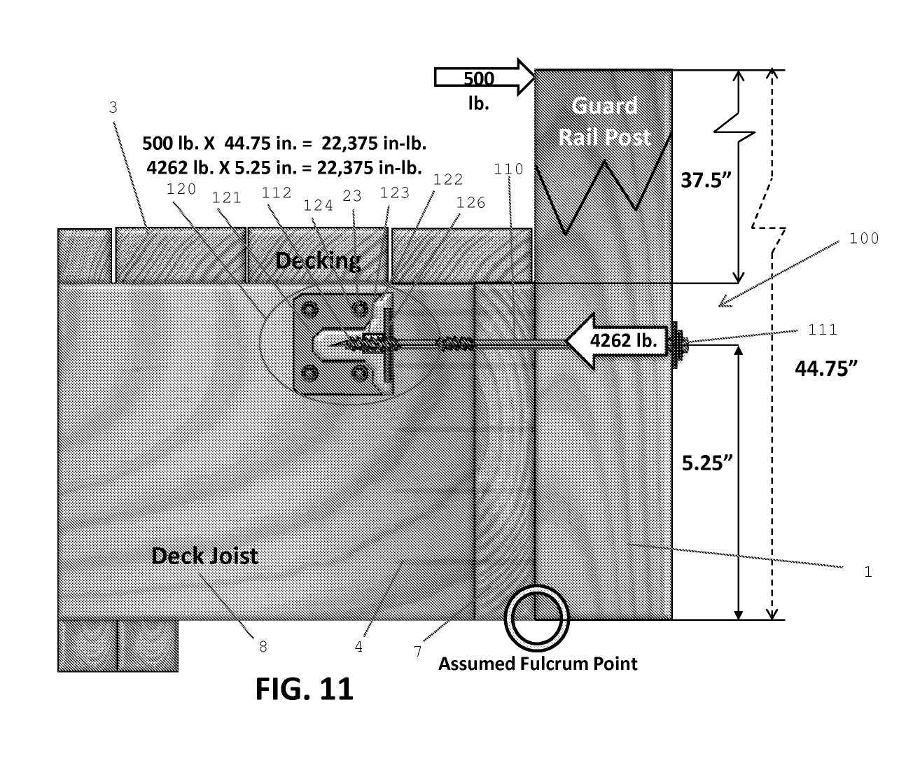

FIGS. 10 and 11 illustrate the pullout force resistance capabilities of connecting assemblies according to the invention. One advantage of connecting the deck guard rail post 1 with a connector loaded in shear (if using wood, across the grain) to a deck joist 8, which does not rely on anchoring the rim joist to the end grain of the deck joist 8, is illustrated. In such connections according to the invention, the connectors are stronger than conventional securing means and/or techniques and are more capable of resisting pullout and/or breakage and/or any other mode of failure.

Connecting device 100 includes a fastener 110, which is driven and/or inserted through the guard rail post 1 and includes a threaded end 112. The threaded end 112 is engagably received in a complementary threaded bore 123 of a ferrule or ferrule/face plate 123/126 combination. The anchor plate 120 includes a planar surface 121, which engages against the side of the deck joist 8 and is fastened by four fasteners 23, which extend through the plate 121 at holes 124. The shank 110 of the fastener is torqued into the threaded bore 123 of anchor member 120 by applying a torque to the head 111 to pull the building components together, including the deck joist 8, the deck rim joist 7, and the guard rail post 1 for a secure deck system and sufficiently support deck boards 3.

As illustrated, the rim joist 7 can be nailed into the deck joist 8 through the end of the deck joist 8, however, this is typically not very strong connection because of the securement through the end grain, which does not resist pull out as well as securement of fasteners loaded in shear (against the grain of the material, e.g., wood). It is important to note that FIGS. 10 and 11 include values for dimensions and loads that are relevant to this embodiment in particular and may or may not be applicable to other embodiments. In general it should be understood that in this disclosure these values will change with different applications. And thus should not be interpreted as decreasing the usefulness and/or breadth of coverage of the devices, systems, and methods described herein.

The positioning of the connector 100 as illustrated will also have a bearing on the strength of the deck guard rail post 1 with respect to resisting a 500 pound force, for example, as applied to the rail post shown in FIGS. 10 and 11. Building codes typically mandate a 200 lb. minimum resistance force and 500 lbs. represents a 2.5 times safety factor. Note the fulcrum point of the rail post against the lower end of the rim joist and the pullout rating factor resistance (within the enlarged arrows) required by the connector device 100 for the two different positions of the connector assemblies exemplified in FIGS. 10 and 11. In preferred embodiments, the connectors are positioned on the building structure in a manner to lower the amount of pullout resistance needed. Indeed, the connecting assemblies can be installed in any position and any number of assemblies can be used to achieve a particular result.

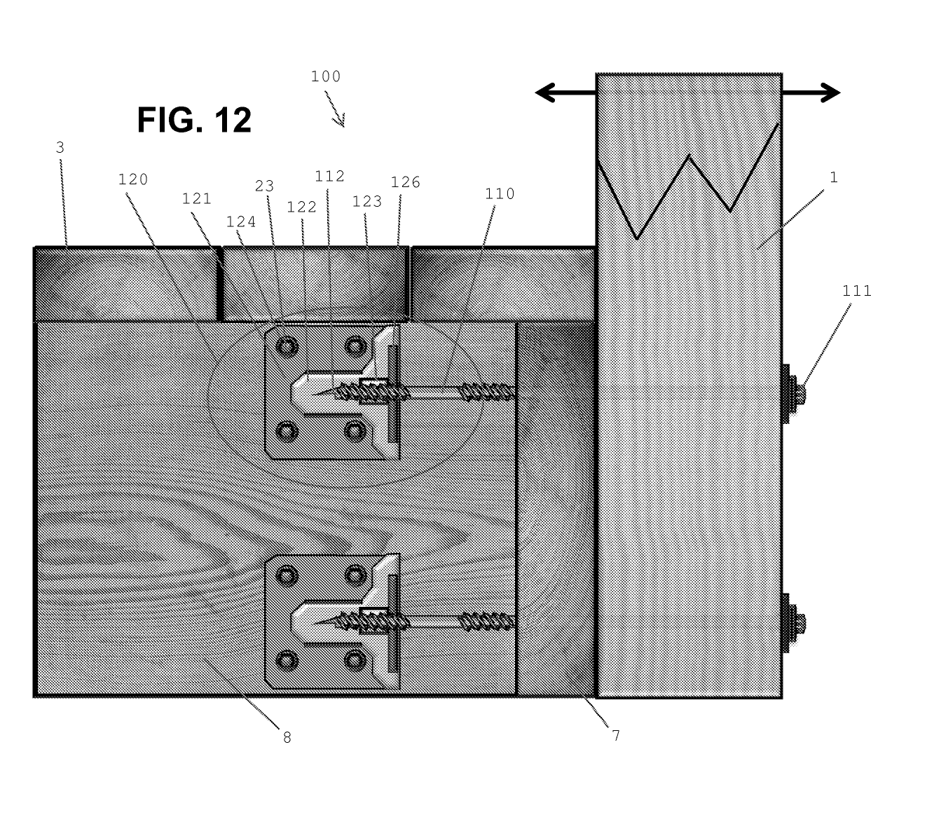

FIG. 12 shows an installation employing a pair of connecting devices 100 for connecting a guard rail post 1, to a rim joist 7, to a deck joist 8, which support deck boards 3 in an overall deck system. A planar portion 121 of an anchoring plate 120 comprises openings 124 for receiving fasteners 23 to fasten the anchoring plate 120 against a side of the deck joist 8 across the grain (loaded in shear). The distal end 112 of a fastener shank 110 is threaded and threadably engages a ferrule 123 held captive within a housing 122. Within the housing 122, the ferrule 123 may also comprise a face plate 126. The ferrule 123 or ferrule/face plate member 123/126 may be free floating within the captive housing 122 or may be fixed thereto. If free floating, this allows for offset alignment of the fastener shaft 110 into the ferrule 123 after a perhaps less than perfect installation. As the fastener 110 is turned, it is pulled into the ferrule 123, which is in turn pulled against the housing of the anchor 120, which in turns pulls on the fasteners 23 loaded in shear into the deck joist 8. In this manner, a secure connection is provided between the rim joist 7 and the deck joist 8, which does not rely on installing fasteners into the end of the deck joist 8, which is a typically weak connection.

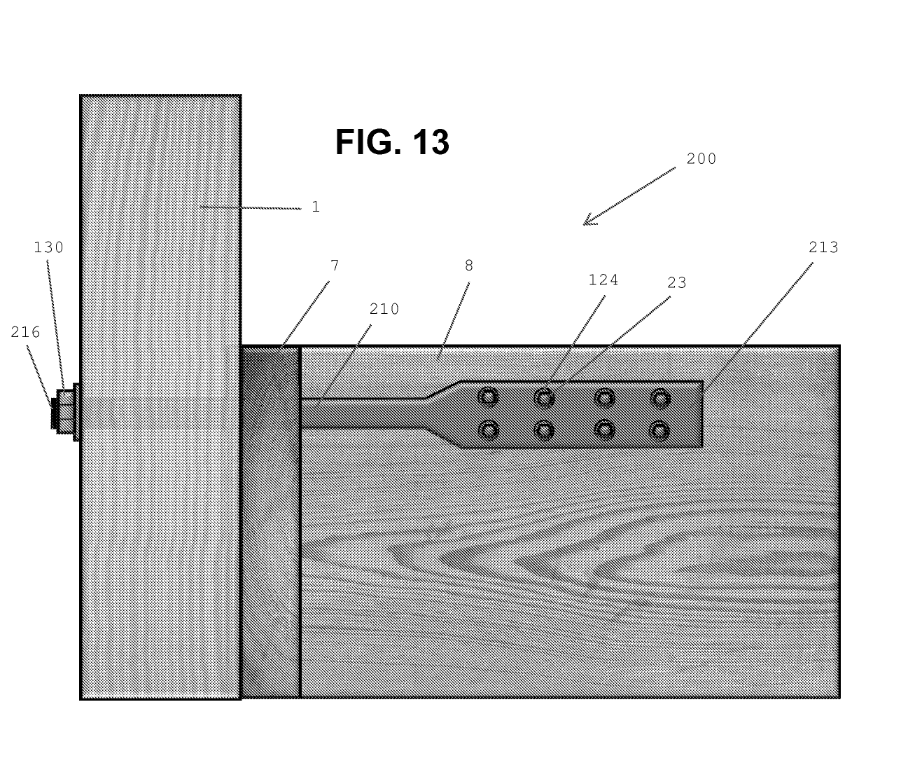

FIG. 13 provides another example of a joint superiorly resistant to pullout forces exerted against the rim joist 7 using the connector devices and assemblies 200 of the invention. As shown, a connecting device 200 includes an elongated shank 210 which integrally transitions into or connects with an anchor portion, such as a flat paddle or paint stirrer-type configuration 213. The end 112 of the shank 110 is threaded. Pre-drilled bores in the rim joist 7 and the deck guard rail post 1 receive the threaded end 112 of the shank of the connecting device. The flat paddle shaped anchor 213 is fastened against the side of the deck joist 8 by way of fasteners 23 inserted through holes 124 in planar member 213. A nut and washer assembly 130 is then torqued against the outside of the post 1 for securing the post to the deck system. This is another example of a fortified connection using a loaded in shear technique.

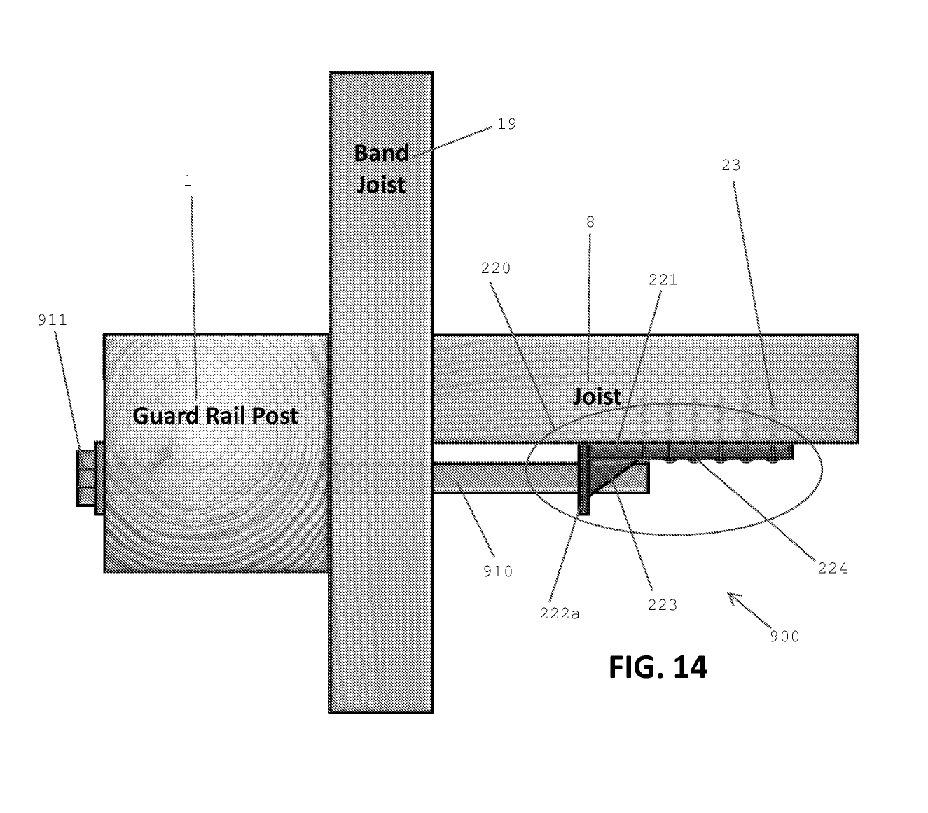

The same joint configuration (rail post, band joist, and joist) that is shown in FIG. 13 is shown again in FIG. 14 as a top plan view, but using another connecting assembly 900 according to the invention. In particular, L-shaped anchor member 220 can be secured through the side of the deck joist 8 loaded in shear or generally across the grain using multiple fasteners 23 inserted through holes 224 in anchor 220. An elongated bolt 910 connects through pre-formed bores of a guard rail post 1 and a rim joist 7 by being inserted therethrough until its head 911 is flush against the outside surface of the guard rail post 1. The opposing end of the bolt 910 is threaded and is received in a threaded complementary socket, ferrule, or opening 223 of the anchor plate 220 and is operably configured to retain the shaft 910 therein. The strength of the anchor member 220 can be increased by using a socket or ferrule, but an opening in an L-shaped anchor 220 can also be used, especially if the face plate 222a in which the opening is disposed is supported by shear walls to resist or prevent the face plate from bending forward as tension is increased with the bolt.

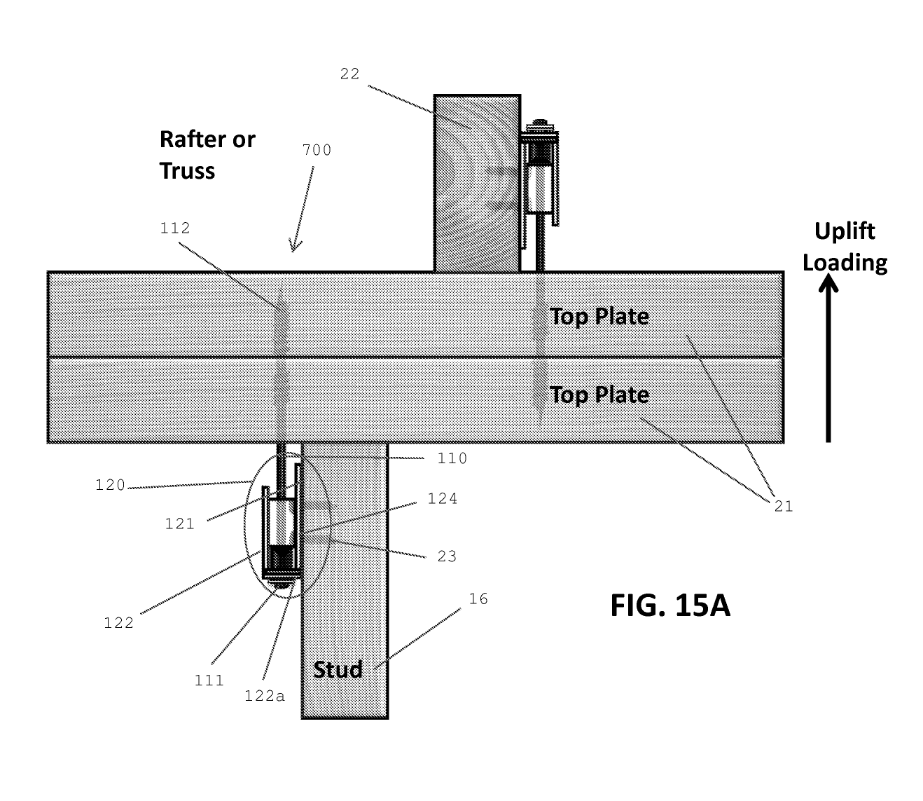

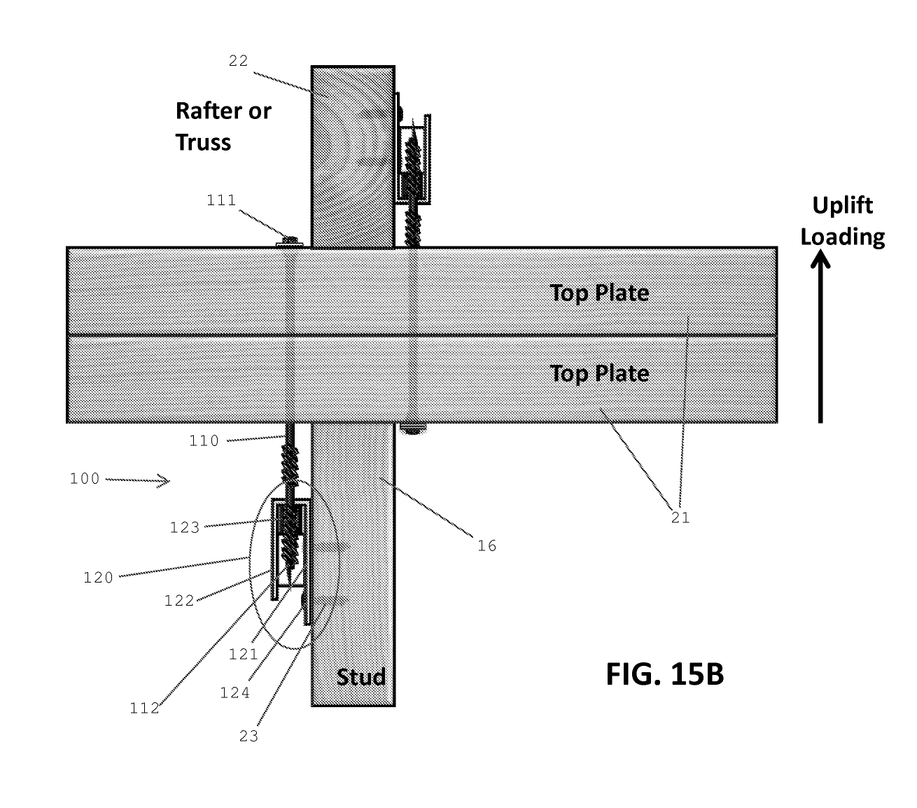

FIG. 15A shows how connector assemblies 700 according to the invention can be used to stabilize a roof system by securing a rafter or truss 22 to abutting top plates 21 and by securing the abutting top plates 21 to a stud 16. As shown, two connector assemblies 700 are used to connect, support, and strengthen the connections. A first anchor member 120 is fastened to a side of a rafter/truss 22, while a second anchor plate 120 is fastened to a side of a stud 16 (typically, a side opposing the side of the rafter to which the first anchor is secured) using several fasteners 23 inserted through holes 124 in planar portion 121, (e.g., screws, nails or bolts, with self-drilling members preferred for this embodiment), which are driven or otherwise inserted into the substrate truss or stud loaded in shear (i.e., against/across the grain, if using wood). The shank 110 of a first elongated cylindrical shaft is loaded into the first anchor 120 until its head 111 abuts with the front wall 122a of the anchor housing 122 and driven and/or inserted into the abutting top plates 21. The shank of a second elongated fastener 110 is likewise inserted into the second anchor 120 and driven and/or inserted into the abutting top plates in a direction directly opposing the direction of insertion of the first elongated cylindrical shaft 110 (reverse orientation). The head 111 of each shaft 110 is tightened against each anchor member 120 until the joint is secure. Constructed in this manner, the joint system is capable of resisting uplift loading conditions.

FIG. 15B shows the same building system configuration as in FIG. 15A, however, using an alternative connector assembly embodiment according to the invention to support and secure the joint against an uplift loading condition. As shown, two connector assemblies 100 are used to connect, support, and strengthen the connection between a rafter 22 and abutting top plates 21. It is not critical that abutting top plates be used and it would be equally applicable to use a single, thicker support member in place of the top plates. The shank 110 of a first elongated fastener is driven and/or inserted through the abutting top plates 21 (with a pre-drilled bore or no bore). The shank of a second elongated fastener 110 is likewise inserted through the top plates 21 in reverse orientation and along an opposing side of a stud 16. This provides heads 111 and a washer secured against the top plates 21, one on an upper face and one on a lower face of the top plates. Threaded end 112 of elongated fastener 110 is operably configured for being threadably received into and retained by a threaded portion of ferrule 123 of anchor plate 120. One of the anchor plates 120 is fastened to a side of rafter or truss 22, while the other anchor plate 120 is fastened to an opposing side and in reverse orientation of a stud 16 using multiple fasteners 23 inserted through holes 124 in planar portion 121, (here, screws), which are driven into the respective substrate and loaded in shear with respect to the substrate (i.e., against/across the grain, if using wood). By turning the heads 111 of the connector assembly shafts 110, the shafts are pulled into anchor member 120 by the threads of ferrule 123 interacting with and retaining the threads 112 of the shaft 110 to pull the shaft 110 into the anchor housing 122. Further, the top plates 21 are pulled toward one another, the rafter 22 is pulled toward the top plates, and the stud 16 is pulled toward the top plates, thereby increasing tension among the components of the building system and securing or stabilizing the joint.

FIG. 16 illustrates use of connector assemblies 800c according to the invention for securing walls or studs 16 to a foundation 20. Secured in the manner illustrated, the building system is capable of resisting an upload condition greater than the structure without the connector assembly. More particularly, an L-shaped foundation anchor 170 is fixed in foundation 20 with a threaded cylindrical end 171 (anchor bolt) in a manner that presents the threaded portion of the anchor bolt 171 above sill plate 17. A coupler/adapter 160 is disposed on the threads 171 of the anchor bolt 170 in a manner to retain the anchor bolt therein by way of opening 162 (can also comprise a threaded ferrule). The remainder of connector assembly 800c is then secured to the stud 16 by disposing the planar member 121 of the anchor 120 flush against a face of the stud 16 and securing the anchor 121 to the stud using fasteners 23 inserted through holes 124 of the anchor plate 121. An elongated cylindrical fastener/shaft 110 is then inserted into anchor 120 through a hole disposed in front wall 122a of the housing 122, until the head 111 of the shaft 110 contacts (a washer can be inserted between the anchor member 120 and the head 111) the anchor 120 and is supported therein. The shaft in this embodiment is partially protected by the anchor housing 122 and the side walls 127 (only the edge of the wall is shown). The opposing end 112 of the shaft 110 is threaded and is received by the coupler 160 and retained therein by opening 161 (can also be a threaded ferrule). The joint is then secured by turning the head 111 of the shaft 110 to push the shaft 110 further into coupler 160, wherein the shaft 110 is retained under tension. In this manner, the stud 16 is drawn toward the sill plate 17 and foundation 20 and secured thereto.

FIG. 17 illustrates an advantage of having anchor member 120 comprise a floating ferrule 123 and/or ferrule/face plate 123/126 combination. As shown, anchor member 120 comprises a planar portion 121, which is secured to the side of support 8 using fasteners 23 inserted into holes 124 in the planar member 121. Shaft 110 is driven into an abutting support 19 toward the ferrule 123 comprised within the housing 122 of the anchor plate 120. During installation of building systems it is typical for the shaft of a fastener to be inserted into the support in a slighting offset manner making communication with the anchor difficult if not impossible. Having a free-floating ferrule 123 or ferrule/face plate 123/126 combination allows for the components of the connecting assembly to meet at such offset angles. Accordingly, such embodiments allow for different angles of shank insertion into the anchor members.

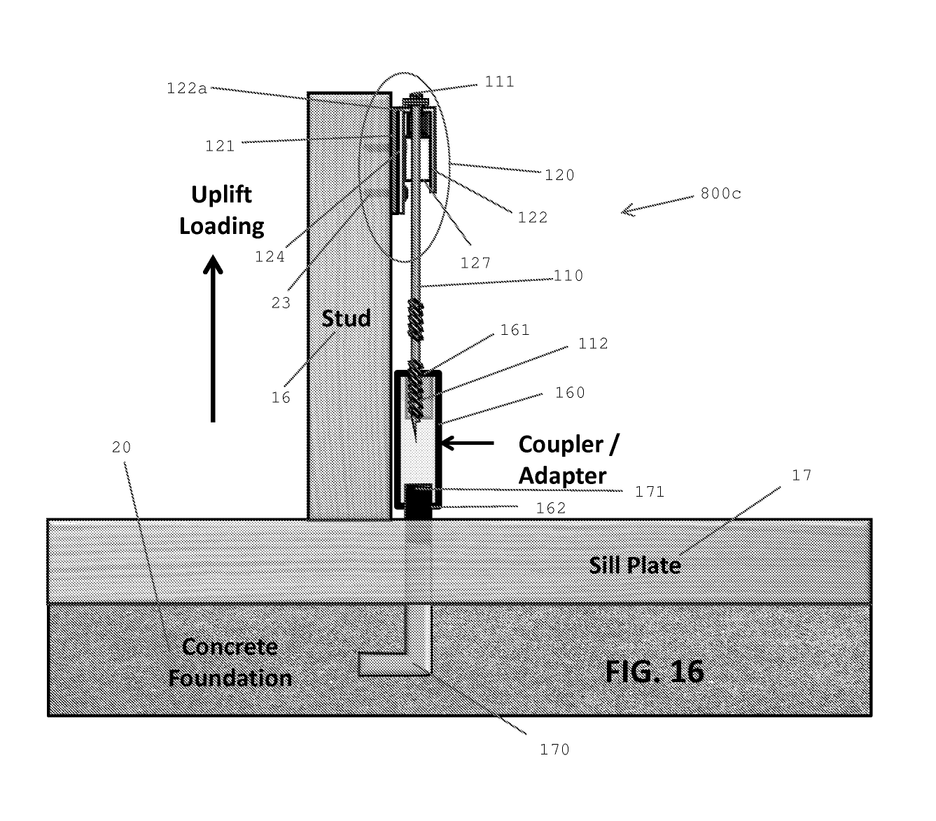

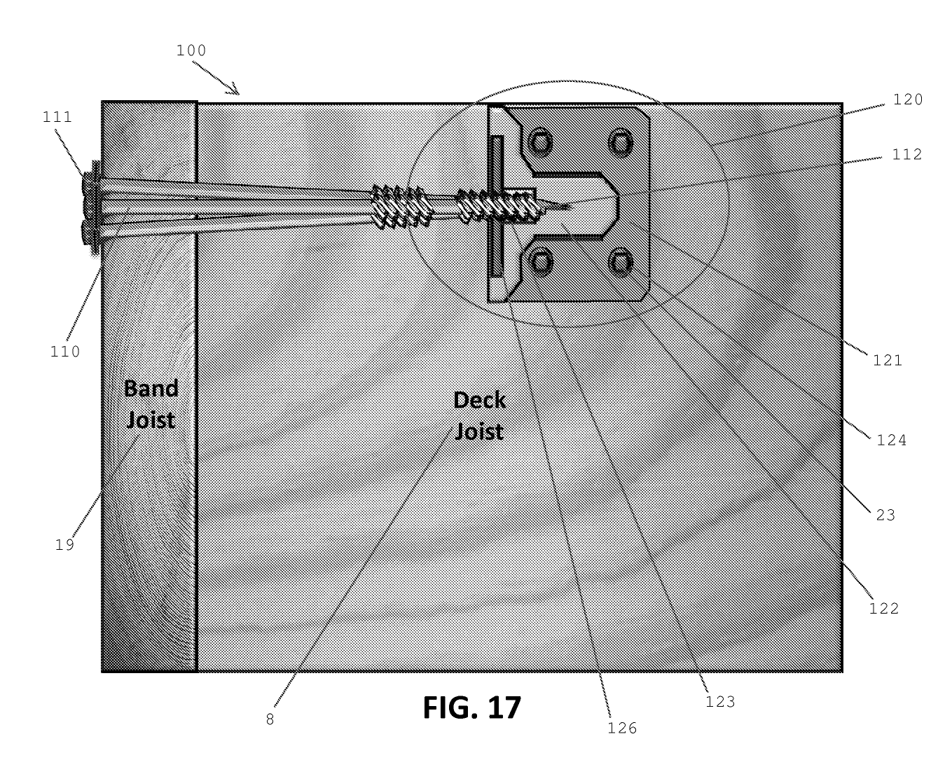

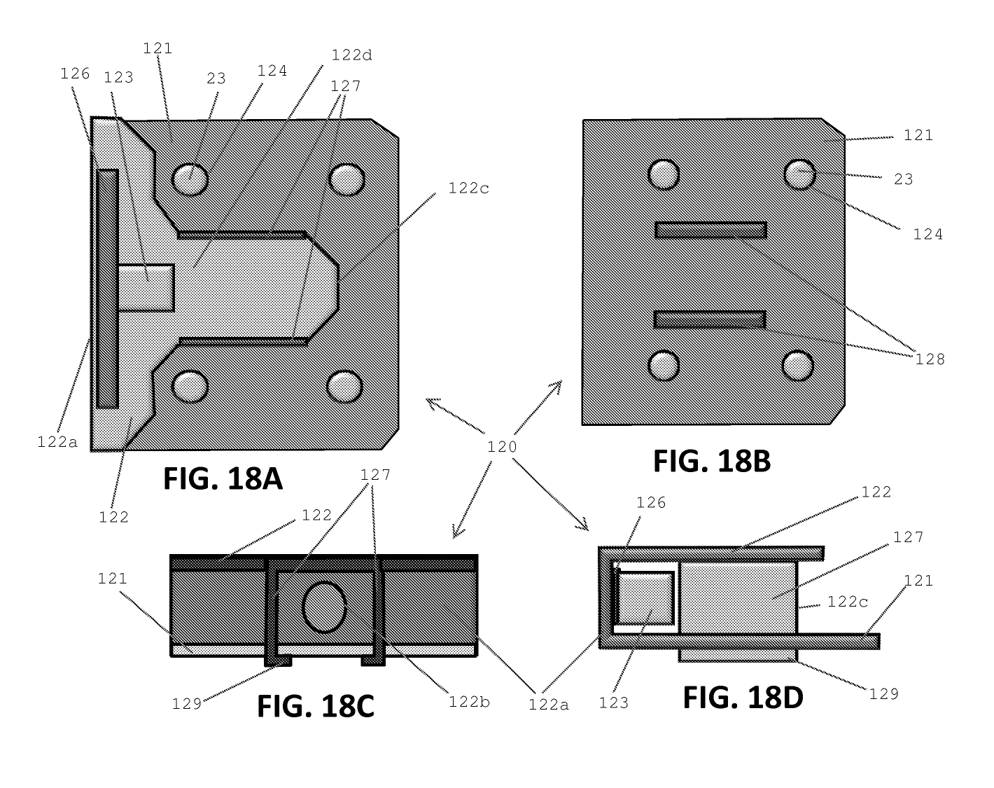

FIGS. 18A-D provide schematic top, bottom, front, and side views, respectively of an embodiment of an anchor member 120 of the invention. As shown, anchor member 120 can comprise a planar support plate 121 for mounting against the face of a substrate. The anchor is secured to a substrate by inserting multiple fasteners 23 (can be any number of fasteners, such as from 1-10) through holes 124 of the anchor into the substrate to provide the fasteners 23 loaded in shear with respect to the substrate. In embodiments, the anchor 120 further comprises a housing 122 for protecting the end of a shaft 110 inserted into the anchor 120.

In preferred embodiments, the housing 122 is formed from the same sheet of material that the anchor plate 121 is derived from and the material is folded over the anchor plate 121 in a manner to provide an arched housing (can be a squared arch) having a front face 122a with an opening 122b for receiving a shaft, having a top wall 122d, a back wall 122c, and opposing side walls 127 that penetrate through the bottom plate at slits 128 where the protruding material 129 is bent over the bottom of the anchor plate 121 (or flanged, or welded). This adds strength to the anchor 120 when tension is applied by the shank fastener 110 into a ferrule 123 held captive by the anchor housing 122. Optionally, the anchor member 120 can comprise a face plate 126 in combination with the ferrule 123, which is configured to restrict motion of the ferrule 123 in one or more directions within the housing.

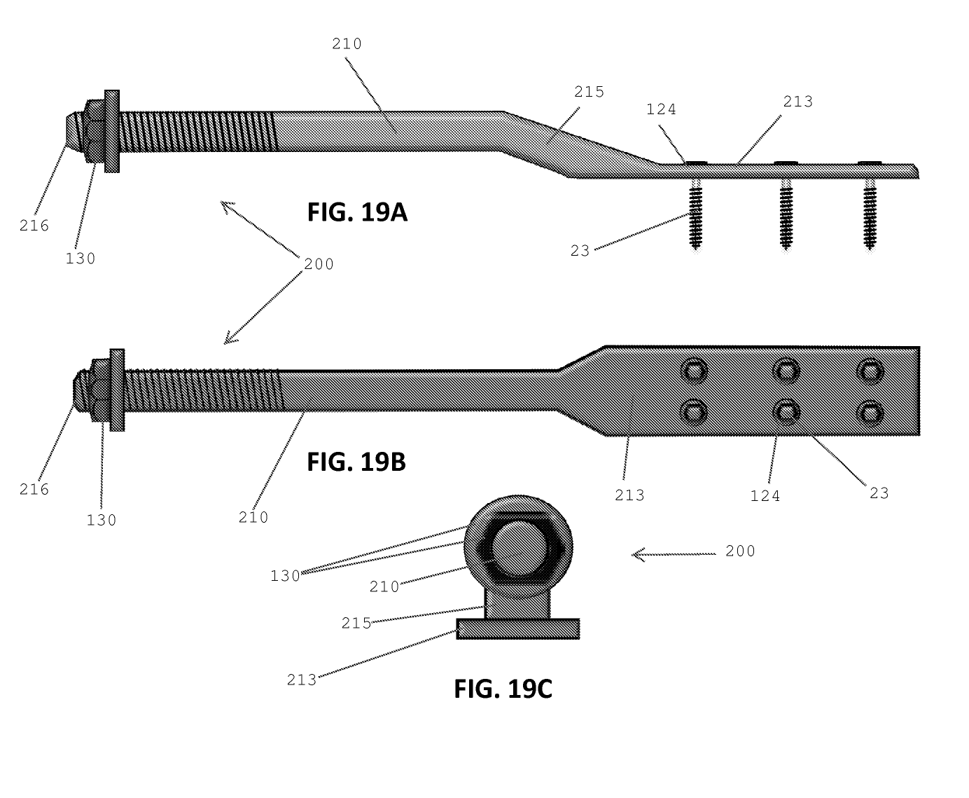

FIGS. 19A-C show a connecting assembly 200 according to the invention. This embodiment comprises a connecting device 200 comprising an elongated shaft 210 having external threads 216 on one cylindrical first end of the shaft and operably configured at an opposing second anchor end 213 of the shaft to be capable of being secured by fasteners 23 through holes 124 to a substrate in a manner in which the fasteners 23 are loaded in shear relative to the substrate. In embodiments, the connecting assembly 200 comprises an anchor portion, which is non-threaded and transitions from the threaded shaft terminating into a planar surfaced member 213. Further preferred are such devices, wherein the shaft 110 comprises a sloped transition area 215 into the anchor portion 213 which provides the shaft 110 and anchor 213 offset relative to one another. The device can further comprise a nut 130 operably configured to receive and retain the cylindrical threaded end of the shaft 216. If employed in a deck system to stabilize a band joist or rim joist to which a deck guard railing (not shown) is attached, upon applying a force to the railing, which is typically attached to the rim joist, the rim joist will resist pullout from the overall deck system better than if the connecting devices of the invention are not used.

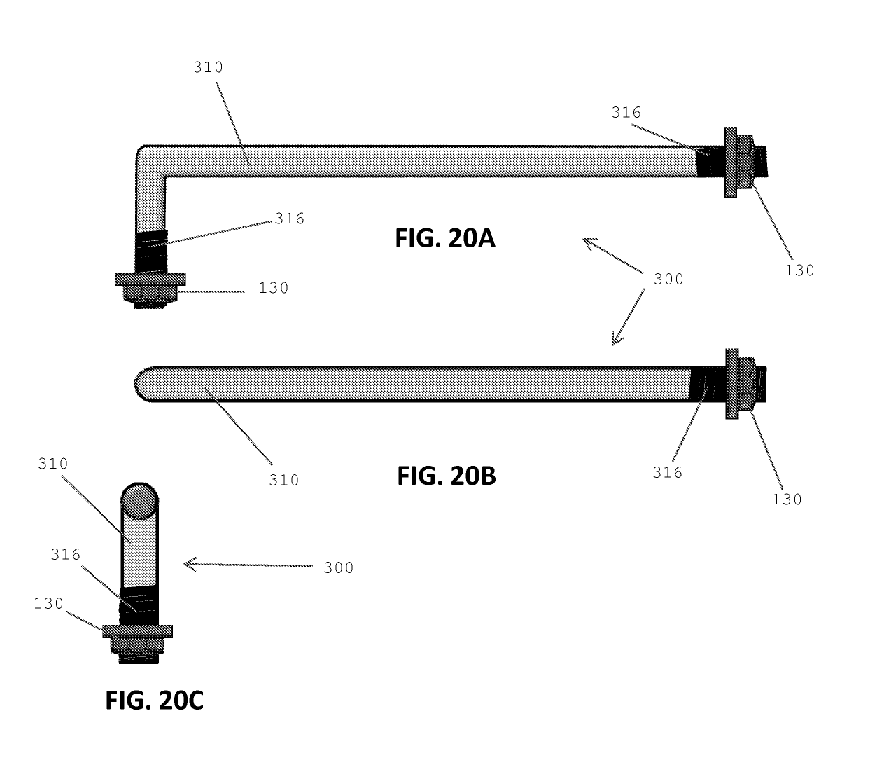

FIGS. 20A-C illustrate connectors 300 of embodiments of the invention. As shown, the connecting assembly 300 comprises an elongated and cylindrical L-shaped shaft 310 having external threads 316 on each of two ends of the shaft. The connecting assembly 300 can further comprise a nut 130 operably configured to receive and retain one threaded end 316 of each end of the L-shaped shaft 310. It is not critical the exact configuration of the “L” so long as it is adapted to a particular building system for which it is intended. For example, the two legs of the shaft terminating at threaded ends 316 can be of any length. On leg can be longer, as shown, or both can be the same length. The bend in the shaft 310 can be any and is not limited to orthogonal bends, however, the most universal connectors will most likely be configured with an approximately orthogonal bend.

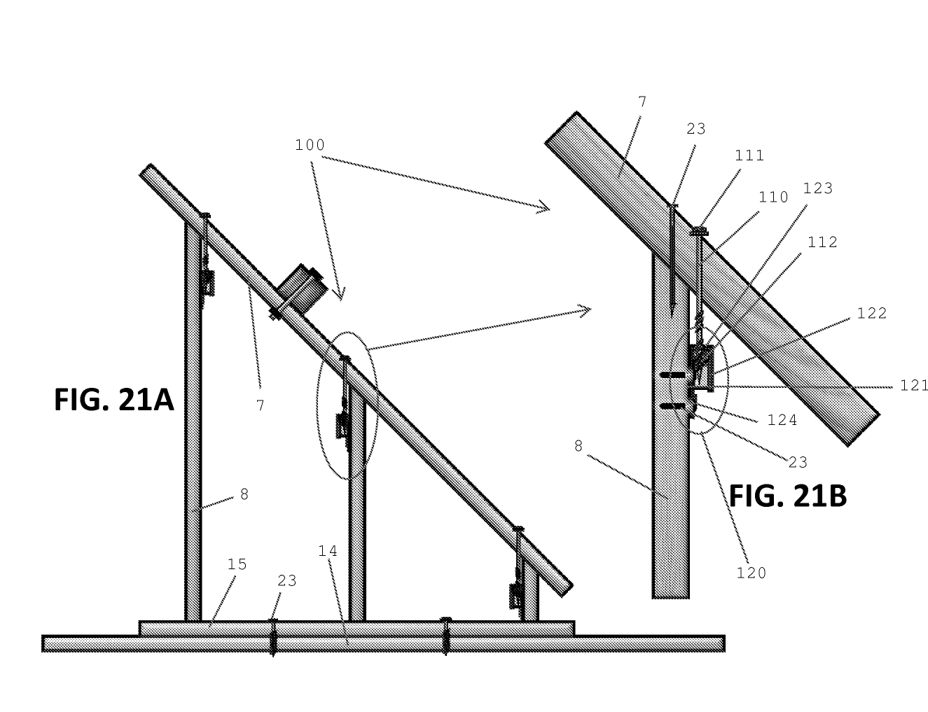

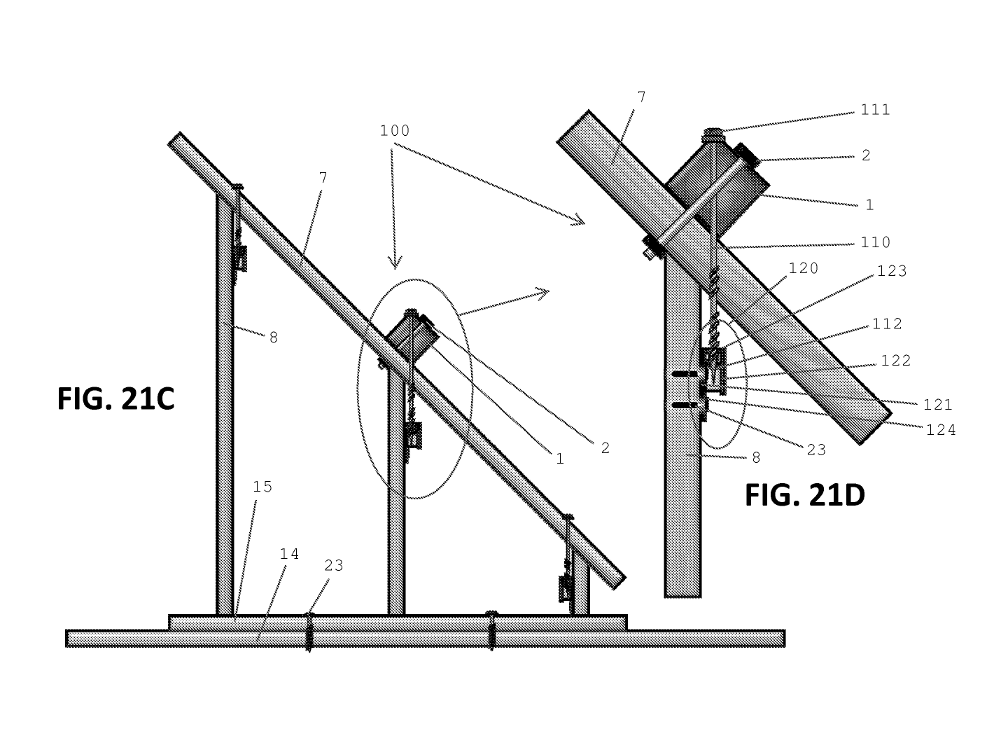

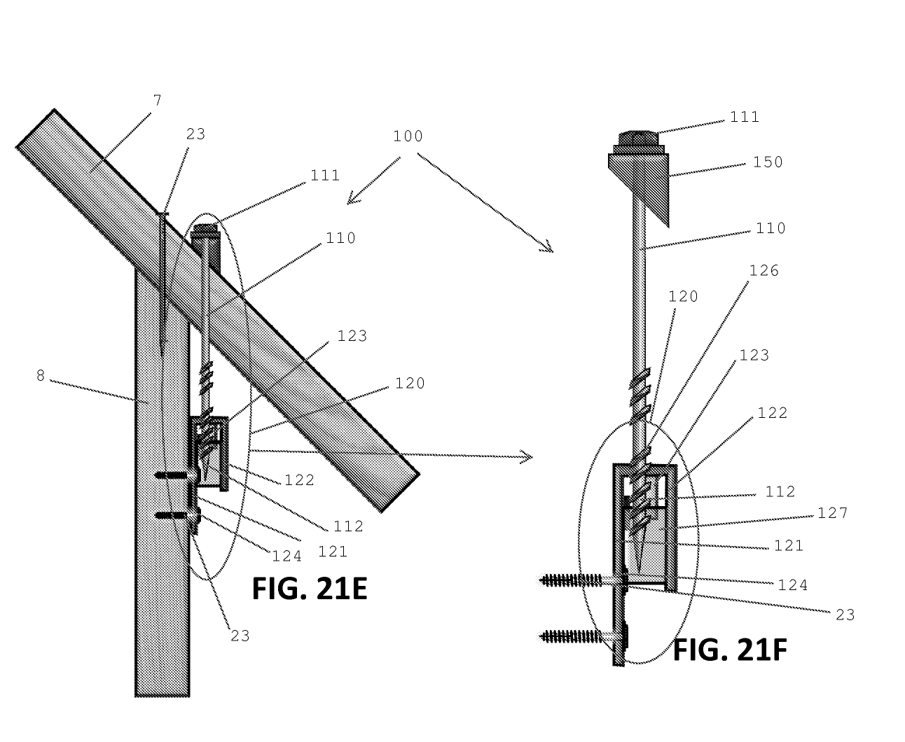

FIGS. 21A-F demonstrate use of connectors 100 according to the invention for installation on a joint between two building components where the members abut one another at other in other than a perpendicular manner. As shown in FIGS. 21A-F connector assembly 100 is installed for securing a deck joist 8 to a deck rim joist 7, where the two substrate joists (building components) abut one another at approximately a 45° angle. Although not shown, the deck system can be attached to a house (through the deck ledger board 15 and the house rim joist 14, which are shown for simplicity sake attached together using screws 23) with one or more connectors and according to one or more methods described in this disclosure. For attaching the deck rim joist 7 to the deck joist 8, a connecting assembly 100 is secured to the deck joist 8 by fastening the anchor member 120 with screws 23 to the deck joist 8 loaded in shear and the planar surface 121 of the anchor abutting the surface of deck joist 8. The fastener/connector shaft 110 is then driven into the deck rim joist 7 toward the front of the anchor housing 122, within which is disposed a ferrule 123 for receiving and retaining the threaded end 112 of the shaft. As the head 111 of the shaft is turned, it is driven deeper into anchor 120, wherein it is retained by the ferrule 123 under tension. This connection can be used alone, with one or more connecting assemblies according to the invention, and/or in combination with existing technology, such as using screws 23 to fasten the deck rim joist 7 to the deck joist 8 through the end of the deck joist instead of the side. Using the connectors 100 will result in a stronger joint capable of withstanding a greater pullout force than using the conventional technology alone.

FIGS. 21C and 21D further illustrate a method by which a deck post 1 can be included in the securing of the deck system using connectors 100. More particularly, a deck guard rail post 1 can be secured to the deck rim joist using conventional bolts 2. Then the procedure outlined just above for securing the deck rim joist 7 to the deck joist 8 can be followed, with the addition of including the deck rail 1 within the same connecting assembly as used for the joists. Specifically, the shaft 110 can be driven through the deck post 1, then through the deck rim joist, and toward the anchor 120. It will be appreciated that the shaft 110 can be of any length and will need to be longer to also accommodate the deck post 1 in the connection. If assembled in this manner, the deck railing attached to the deck posts 1 will be capable of withstanding pullout forces greater than the pullout forces that would be needed to detach a railing/rim joist from a deck system if using conventional means for securing the components.

Further provided in FIGS. 21E and 21F, is an embodiment of the connectors 100 according to the invention further comprising a sloped spacer member 150, which is a hollow cylinder sloped on one end and operably configured to contact and support the head 111 (optionally with or without intermediate washers) of the shaft at an opposing end, and which provides a support surface for the head of the shaft disposed at a selected distance from a substrate (here, the deck rim joist 7). Any degree of slope can be used and the slope should be appropriate for a particular installation. In this embodiment, the slope of the spacer member 150 is approximately the same as that of the relative position between the joists 7, 8, about 45°. An advantage of using the spacer member 150 with connectors of the invention is that for non-perpendicular rim joist/deck joist installations the head 111 of the shaft 110 of the connecting assembly 100 is provided a horizontal support on which to rest instead of a slope. Installations performed in this manner will result in deck systems that are capable of resisting greater pullout forces than if using conventional screws alone.

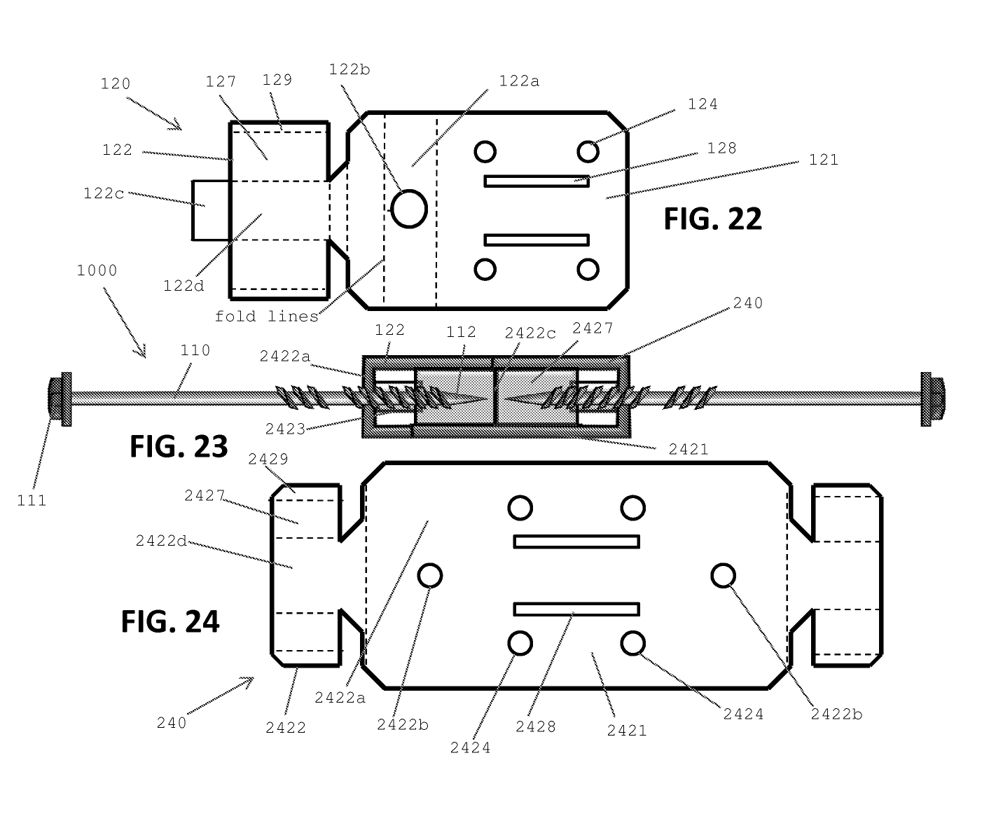

FIG. 22 is an illustration of an anchor according to the invention. Anchor 120 can be formed from a single sheet of material (e.g., sheet metal) and constructed by folding the material along the dotted lines (some fold lines omitted). Planar surface 121 is used to abut a surface of a substrate to which the anchor 120 would be secured during installation. The front of the housing 122a would then be folded at a right angle with respect to the planar surface 121. In the front 122a of the housing 122, is disposed an opening 122b for receiving a shaft-type fastener. The housing 122 is further constructed by folding it into a box configuration over the planar member 121. In this manner, side walls 127 support the housing structure by securing portions 129 through slots 128 and under planar member 121. The back 122c of the housing 122 is then folded down and disposed at a right angle to planar member 121. In this manner, a housing can be constructed for receiving and retaining a fastener and protecting the end of the fastener within the housing by completely enclosing it in the housing box formed from the planar member 121, the front member 122a, the side wall members 127, the top member 122d, and the back member 122c. Optionally, a ferrule or ferrule/face plate combination (both are not shown) can be included within the housing for receiving and retaining the shaft of the fastener. The ferrule or ferrule/face plate combination can be secured or unsecured (free-floating) within the housing 122.

FIG. 23 is a representative connecting device according to the invention comprising an anchor 240 capable of performing as a tensioner (e.g., turnbuckle), which is capable of receiving and retaining two opposing elongated cylindrical shaft-type fasteners 110. Anchor 240 in this embodiment comprises a double housing 122 (back-to-back configuration) formed from a planar member 2421, a front housing member 2422a, a top 2422d, side walls 127 and an optional back wall 2422c. Ferrule 2423 receives and retains the threaded 112 portion of a shaft-type fastener due to the ferrule being threaded in its interior. The ferrule 2423 of the opposing opening in the anchor is threaded in a reverse direction to perform as a tensioner.

FIG. 24 is an illustration of the double anchor/tensioner shown in FIG. 23. The double anchor 240 can be formed from a single sheet of metal as well, similarly to the method described above for FIG. 22. Once folded upon itself, two back-to-back (opposing) housings 2422 are formed from top 2422d, front 2422a, planar support member 2421, and sides 2427. The housing 2422 is secured by members 2429 inserted through slots 2428 and protruding below and folded under planar surface support member 2421. An opening for receiving a shaft 2422b can be included in the face of front 2422a. The double anchor 240 is secured to a substrate by fasteners inserted through holes 2424. Optional ferrules or ferrule/face plate combinations (not shown) can be included as captive within each of the housings 2422 for receiving and retaining a shaft. The ferrule of one housing 2422 can be threaded in one direction and the ferrule of the opposing housing 2422 can be threaded in reverse so that the anchor functions as a tensioner or turnbuckle upon installation in a building system.

Other uses for the connecting assemblies of the invention include employing the devices in building kits comprising building components, such as joists, trusses, studs, etc., for quick and easy installation of modular and/or transportable buildings, especially for temporary or emergency use. An advantage of the connector assemblies of the invention includes being able to construct, disassemble, and re-assemble building components without substantial damage (i.e., damage rending the components useless or otherwise subject to failure) to the components.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Further, it will be appreciated that modifications to the above-described embodiments can be made by including elements described in any other embodiment or by using less than or otherwise omitting any detailed feature. The description of the invention provided is merely exemplary in nature and, thus, variations that do not depart from the essence of the invention are intended to be within the scope of the invention.

1. A connecting device comprising an elongated shaft having external threads on one cylindrical first end of the shaft and comprising an anchor portion at an opposing second end of the shaft having means for receiving a plurality of fasteners at a right angle relative to and through the shaft.

2. The device of claim 1, wherein the second end of the shaft is not threaded and terminates into an anchor portion having a planar surface.

3. The device of claim 2, wherein the anchor portion comprises a plurality of openings for receiving screw-type fasteners.

4. The device of claim 2, wherein the shaft comprises a sloped transition into the anchor portion which provides an upper surface of the shaft and an upper surface of the anchor offset relative to one another.

5. The device of claim 1 further comprising fasteners for securing the device to a substrate and a nut operably configured to receive and retain the cylindrical end of the shaft.

6. The device of claim 1 further comprising:
an L-shaped foundation anchor having a threaded end; and
a turnbuckle operably configured for receiving and retaining each of the threaded ends of the shaft and the threaded end of the foundation anchor.

7. A connecting device comprising an elongated and cylindrical L-shaped shaft having external threads on each of two ends of the shaft.

8. The connecting device of claim 7 further comprising:
a nut operably configured to receive and retain one threaded end of the shaft;
an L-shaped foundation anchor having a threaded end; and
a turnbuckle operably configured for receiving and retaining each of the threaded ends of the shaft and the foundation anchor.

9. The device of claim 7 further comprising nuts operably configured to receive and retain each cylindrical end of the shaft.

10. (canceled)

11. (canceled)

12. (canceled)

13. (canceled)

14. (canceled)

15. A connecting assembly comprising:
an elongated cylindrical shaft externally threaded at a first end and comprising a head with a diameter larger than the shaft at a second end; and
an anchor member which is separate from the shaft and comprises means for receiving, contacting, and retaining multiple threads of the first threaded end of the shaft and further comprises means for receiving a plurality of fasteners at a right angle relative to the anchor member.

16. The assembly of claim 15, wherein the anchor member is operably configured with an interior ferrule for receiving, contacting, and retaining the threaded end of the shaft.

17. The assembly of claim 16, wherein the ferrule is connected to or integral with a face plate and the ferrule/face plate member is free floating yet captive within a housing of the anchor.

18. The assembly of claim 15 further comprising a sloped spacer member, which is a hollow cylinder sloped on one end and operably configured to contact and support the head of the shaft at an opposing end, and which provides a support surface for the head of the shaft disposed at a selected distance from a substrate.

19-42. (canceled)

43. The assembly of claim 17, wherein the anchor member has a planar portion which comprises through holes as the means for receiving a plurality of fasteners at a right angle relative to the planar portion of the anchor member.

44. The assembly of claim 17, wherein the ferrule and face plate together comprise a T-shaped member.

45. The assembly of claim 44, wherein the anchor member comprises a housing for the T-shaped member configured to retain the T-shaped member in a manner that allows for movement of the T-shaped member within the housing.

46. The assembly of claim 45, wherein the anchor member has a planar portion and wherein the housing comprises an end panel support member disposed perpendicular to the planar portion of the anchor member and which support member retains the T-shaped member within the housing during use.
